(19) United States
(12) Patent Application Publication
(10) Pub. No.: US 2024/0178598 A1
(43) Pub. Date: May 30, 2024

(54) Combined Electrical Connector

(71) Applicant: Tarng Yu Enterprise co., ltd., New Taipei City (TW)

(72) Inventors: YING-CHUNG CHEN, New Taipei City (TW); MU-JUNG HUANG, New Taipei City (TW)

(21) Appl. No.: 18/518,841

(22) Filed: Nov. 24, 2023

(30) Foreign Application Priority Data
Nov. 25, 2022 (TW) 111145330

(51) Int. Cl. H01R 13/22; H01R 13/42

(52) U.S. Cl. CPC H01R 13/22; H01R 13/42

(57) ABSTRACT

A combined electrical connector at least composed of an outer shell component and a tongue component. The tongue component is at least composed of a tongue major conductive terminal assembly and a tongue minor conductive terminal assembly. Therefore, after the electrical connector design is completed, customization and adjustment of the quantity, structure, and electrical connection relationship of the conductive terminals of the electrical connector can still be achieved by adjusting the outer shell component and the tongue component. This allows meeting the specific requirements and developments of electronic devices.

### CROSS-REFERENCE TO RELATED APPLICATIONS

This application claims the priority of Republic of China Patent Application No. 111145330 filed on Nov. 25, 2022, in the State Intellectual Property Office of the R.O.C., the disclosure of which is incorporated herein by reference.

### BACKGROUND OF THE INVENTION

### Field of the Invention

This application is related to the field of electronic device technology, more specifically, it relates to a combined electrical connector that allows for the customization of the number, structure, and electrical connections of conductive terminals.

### Descriptions of the Related Art

In various modern electronic devices, electrical connectors are typically employed to provide signal transmission. However, to meet the specific requirements and advancements in electronic devices, there is a demand for the customization of the number and structure of the conductive terminals in electrical connectors. Presently, once the design of an electrical connector is finalized, the number, the structure, and the electrical connections of conductive terminals become fixed and cannot be customized. This limitation makes it challenging to fulfill the signal transmission needs of electronic devices, ultimately restricting the technological (functional) development of electronic devices.

Furthermore, there might be a need for certain conductive terminals on an electrical connector to be electrically connected to each other. Currently, in the industry, the only solution for achieving electrical connections between certain conductive terminals on an electrical connector is to add jumper adaptors that are compatible with the connector. However, adding these jumper adaptors occupies the interior space of electronic devices, which, in turn, hinders the ongoing trend of making electronic devices smaller and more compact.

Given this situation, customizing the number and structure of the conductive terminals on an electrical connector has become a pressing technical challenge that the industry is eager to overcome.

### SUMMARY OF THE INVENTION

In view of the drawbacks of the prior art mentioned above, the present application provides a combined electrical connector, which is used with a joining element, comprising: an outer shell component providing joining with the joining component wherein the outer shell component has an outer shell terminal joining port; a tongue component including a tongue base, a tongue insulation terminal frame, a tongue bridging conductive metal, a tongue major conductive terminal assembly, and a tongue minor conductive terminal assembly; wherein the tongue major conductive terminal assembly has a tongue major bridging conductive terminals and a tongue major non-bridging conductive terminal, and the tongue minor conductive terminal assembly includes a plurality of tongue minor bridging conductive terminals and a tongue minor non-bridging conductive terminal; the tongue bridging conductive metal comprises a tongue conductive metal connection structure, a tongue conductive metal major abutting structure, and a tongue conductive metal minor abutting structure; the tongue base includes a tongue base separation wall; the tongue insulation terminal frame includes a tongue insulation terminal frame major joining structure and a tongue insulation terminal frame minor joining structure, and the tongue insulation terminal frame major joining structure and the tongue insulation terminal frame minor joining structure are used to respectively join with one side of the tongue major conductive terminal assembly and the tongue minor conductive terminal assembly, providing positioning for the tongue major conductive terminal assembly and the tongue minor conductive terminal assembly; wherein the tongue base, the tongue insulation terminal frame, the tongue bridging conductive metal, the tongue major conductive terminal assembly, and the tongue minor conductive terminal assembly are combined to form a tongue component combination, within the tongue component combination, the tongue base separation wall separates the tongue major conductive terminal assembly from the tongue minor conductive terminal assembly, wherein the tongue conductive metal connection structure extends to respectively cross over the tongue major non-bridging conductive terminal and the tongue minor non-bridging conductive terminal, allowing the tongue conductive metal connection structure to respectively electrically connect with the tongue conductive metal major abutting structure and the tongue conductive metal minor abutting structure, and the tongue conductive metal major abutting structure abuts to each of the tongue major bridging conductive terminals, and the tongue conductive metal minor abutting structure abuts to each of the tongue minor bridging conductive terminals, allowing for the electrical connection of each of the tongue major bridging conductive terminals and each of the tongue minor bridging conductive terminals; and the tongue component is embedded within the outer shell component to form an electrical connector combination, in the electrical connector combination, the contact area of the tongue major conductive terminal assembly and the tongue minor conductive terminal assembly are exposed on the outer shell terminal joining port, allowing the contact area of tongue major conductive assembly and the tongue minor conductive assembly is electrically connected with the joining component when the outer shell component is joined to the joining component.

Preferably, the combined electrical connector said above, wherein the outer shell component further includes an outer shell lingual structure, an outer shell bottom embedding port, and an outer shell interior space, and the outer shell bottom embedding port is located at the bottom of the outer shell lingual structure, while the outer shell interior space is positioned within the interior of the outer shell lingual structure, wherein the outer shell terminal joining port is positioned on the side wall of the outer shell lingual structure, and the tongue component can enter the outer shell interior space through the outer shell bottom embedding port, thereby exposing the contact area of the tongue major conductive terminal assembly and the tongue minor conductive terminal assembly on the outer shell terminal joining port.

Preferably, the combined electrical connector said above, wherein the outer shell component further includes an outer shell component major separation structure and an outer shell component minor separation structure, in the electric connector combination, the outer shell major component separation structure serves to separate adjacent pairs of the plurality of the tongue major bridging conductive terminals from the tongue major non-bridging conductive terminal, and the outer shell minor component separation structure serves to separate adjacent pairs of the plurality of the tongue minor bridging conductive terminals from the tongue minor non-bridging conductive terminal.

Preferably, the combined electrical connector said above, wherein the outer shell component major separation structure and the outer shell component minor separation structure are the fence-like structure.

Preferably, the combined electrical connector said above, wherein the tongue base further includes a tongue base support structure, and the tongue base support structure provides support to the tongue conductive metal connection structure, allowing the tongue conductive metal connection structure to extend on the tongue base.

Preferably, the combined electrical connector said above, wherein the tongue conductive metal connection structure spans across or abuts the tongue base separation wall.

Preferably, the combined electrical connector said above, wherein the tongue bridging conductive metal further includes a tongue conductive metal major separation structure and a tongue conductive metal minor separation structure, and the tongue conductive metal major separation structure extends along the tongue base separation wall, bridging over the tongue major non-bridging conductive terminal to separate the tongue major non-bridging conductive terminal from the tongue minor conductive terminal assembly, wherein the tongue conductive metal minor separation structure extends along the tongue base separation wall, bridging over the tongue minor non-bridging conductive terminals to separate the tongue major conductive terminal assembly from the tongue minor non-bridging conductive terminal.

Preferably, the combined electrical connector said above, wherein the tongue conductive metal connection structure, the tongue conductive metal major separation structure, and the tongue conductive metal minor separation structure are interconnected to form a tongue conductive metal structure, and the tongue conductive metal structure has a U-shaped cross-section.

Preferably, the combined electrical connector said above, wherein the tongue insulation terminal frame further includes a tongue insulation terminal frame joining structure, in the electrical connector combination, the tongue insulation terminal frame joining structure is used to connect to the outer shell component through a snap-in, fastening, or interference method.

Preferably, the combined electrical connector said above, wherein the tongue conductive metal major abutting structure comprises a tongue conductive metal major first abutting substructure and a tongue conductive metal major second abutting substructure, and the tongue conductive metal major first abutting substructure is used to abut against each of the tongue major bridging conductive terminals at a tongue conductive metal major first abutting position, while the tongue conductive metal major second abutting substructure is used to abut against each of the tongue major bridging conductive terminals at a tongue conductive metal major second abutting position, wherein the tongue conductive metal major first abutting position and the tongue conductive metal major second abutting position are different; the tongue conductive metal minor abutting structure comprises a tongue conductive metal minor first abutting substructure and a tongue conductive metal minor second abutting substructure, and the tongue conductive metal minor first abutting substructure is used to abut against each of the tongue minor bridging conductive terminals at a tongue conductive metal minor first abutting position, while the tongue conductive metal minor second abutting substructure is used to abut against each of the tongue minor bridging conductive terminals at a tongue conductive metal minor second abutting position, wherein the tongue conductive metal minor first abutting position and the tongue conductive metal minor second abutting position are different.

Preferably, the combined electrical connector said above, wherein the tongue insulation terminal frame comprises a tongue insulation terminal frame major component and a tongue insulation terminal frame minor component, and the tongue insulation terminal frame major joining structure is located on the tongue insulation terminal frame major component, and the tongue insulation terminal frame minor joining structure is located on the tongue insulation terminal frame minor component, wherein the tongue insulation terminal frame major component includes a tongue insulation terminal frame major assembly structure, while the tongue insulation terminal frame minor component includes a tongue insulation terminal frame minor assembly structure, the tongue insulation terminal frame major assembly structure and the tongue insulation terminal frame minor assembly structure are structurally coordinated, allowing the tongue insulation terminal frame major component and the tongue insulation terminal frame minor component to be assembled into a tongue insulation terminal frame combination.

Preferably, the combined electrical connector said above, wherein the tongue base further includes a tongue base assembly structure, and the tongue base assembly structure is respectively structurally coordinated with the tongue insulation terminal frame major assembly structure and the tongue insulation terminal frame minor assembly structure, enabling the tongue insulation terminal frame major component and the tongue insulation terminal frame minor component to be assembled into the tongue insulation terminal frame combination.

Preferably, the combined electrical connector said above, wherein the tongue base assembly structure, the tongue insulation terminal frame major assembly structure, and the tongue insulation terminal frame minor assembly structure are designed with a protrusion and recess structure which are structurally coordinated.

Preferably, the combined electrical connector said above, wherein the tongue base is an insulation base or a conductive base.

Additionally, the present application provides a combined electrical connector, wherein the combined electrical connector is equipped with a joining component, comprising: an outer shell component providing joining with the joining component; a tongue component including a tongue base, a tongue insulation terminal frame major component, a tongue insulation terminal frame minor component, a tongue bridging conductive metal, a tongue major conductive terminal assembly, and a tongue minor conductive terminal assembly; wherein the tongue major conductive terminal assembly includes a plurality of tongue major bridging conductive terminals and a tongue major non-bridging conductive terminal, and the tongue minor conductive terminal assembly includes a plurality of tongue minor bridging conductive terminals and a tongue minor non-bridging conductive terminal; the tongue bridging conductive metal comprises a tongue conductive metal connection structure, a tongue conductive metal major abutting structure, and a tongue conductive metal minor abutting structure; the tongue base includes a tongue base separation wall; the tongue insulation terminal frame includes a tongue insulation terminal frame major joining structure, and the tongue insulation terminal frame minor component includes a tongue insulation terminal frame minor joining structure, the tongue insulation terminal frame major joining structure and the tongue insulation terminal frame minor joining structure are used to respectively join with opposite sides of the tongue major conductive terminal assembly and the tongue minor conductive terminal assembly, providing positioning for the tongue major conductive terminal assembly and the tongue minor conductive terminal assembly; wherein the tongue base, the tongue insulation terminal frame major component, the tongue insulation terminal frame minor component, the tongue bridging conductive metal, the tongue major conductive terminal assembly, and the tongue minor conductive terminal assembly are combined to form a tongue component combination, within the tongue component combination, the tongue base separation wall separates the tongue major conductive terminal assembly from the tongue minor conductive terminal assembly, wherein the tongue conductive metal connection structure extends to respectively cross over the tongue major non-bridging conductive terminal and the tongue minor non-bridging conductive terminal, allowing the tongue conductive metal connection structure to respectively electrically connect with the tongue conductive metal major abutting structure and the tongue conductive metal minor abutting structure, and the tongue conductive metal major abutting structure abuts to each of the tongue major bridging conductive terminals, and the tongue conductive metal minor abutting structure abuts to each of the tongue minor bridging conductive terminals, allowing for the electrical connection of each of the tongue major bridging conductive terminals and each of the tongue minor bridging conductive terminals; and the tongue component is embedded within the outer shell component to form an electrical connector combination, in the electrical connector combination, the contact area of the tongue major conductive terminal assembly and the tongue minor conductive terminal assembly are exposed on the outer shell component, allowing the contact area of tongue major conductive assembly and the tongue minor conductive assembly is electrically connected with the joining component when the outer shell component is joined to the joining component.

Preferably, the combined electrical connector said above, wherein the outer shell component includes an outer shell bottom embedding port, wherein the tongue component combination enables to enter the outer shell component via the outer shell bottom embedding port to form the electrical connector combination.

Preferably, the combined electrical connector said above, wherein the tongue insulation terminal frame major component further includes a tongue insulation terminal frame major separation structure, and the tongue insulation terminal frame minor component includes a tongue insulation terminal frame minor separation structure, wherein the tongue insulation terminal frame major separation structure serves to separate adjacent pairs of the plurality of the tongue major bridging conductive terminals from the tongue major non-bridging conductive terminal, and the tongue insulation terminal frame minor separation structure serves to separate adjacent pairs of the plurality of the tongue minor bridging conductive terminals from the tongue minor non-bridging conductive terminal.

Preferably, the combined electrical connector said above, wherein the tongue insulation terminal frame major separation structure and the tongue insulation terminal frame minor separation structure are fence-like structure.

Preferably, the combined electrical connector said above, wherein the tongue base further includes a tongue base support structure, and the tongue base support structure provides support to the tongue conductive metal connection structure, allowing the tongue conductive metal connection structure to extend on the tongue base.

Preferably, the combined electrical connector said above, wherein the tongue conductive metal connection structure spans across or abuts the tongue base separation wall.

Preferably, the combined electrical connector said above, wherein the tongue bridging conductive metal further includes a tongue conductive metal major separation structure and a tongue conductive metal minor separation structure, and the tongue conductive metal major separation structure extends along the tongue base separation wall, bridging over the tongue major non-bridging conductive terminal to separate the tongue major non-bridging conductive terminal from the tongue minor conductive terminal assembly, wherein the tongue conductive metal minor separation structure extends along the tongue base separation wall, bridging over the tongue minor non-bridging conductive terminals to separate the tongue major conductive terminal assembly from the tongue minor non-bridging conductive terminal.

Preferably, the combined electrical connector said above, wherein the tongue conductive metal connection structure, the tongue conductive metal major separation structure, and the tongue conductive metal minor separation structure are interconnected to form a tongue conductive metal structure, and the tongue conductive metal structure has a U-shaped cross-section.

Preferably, the combined electrical connector said above, wherein the tongue conductive metal major abutting structure comprises a tongue conductive metal major first abutting substructure and a tongue conductive metal major second abutting substructure, and the tongue conductive metal major first abutting substructure is used to abut against each of the tongue major bridging conductive terminals at a tongue conductive metal major first abutting position, while the tongue conductive metal major second abutting substructure is used to abut against each of the tongue major bridging conductive terminals at a tongue conductive metal major second abutting position, wherein the tongue conductive metal major first abutting position and the tongue conductive metal major second abutting position are different; the tongue conductive metal minor abutting structure comprises a tongue conductive metal minor first abutting substructure and a tongue conductive metal minor second abutting substructure, and the tongue conductive metal minor first abutting substructure is used to abut against each of the tongue minor bridging conductive terminals at a tongue conductive metal minor first abutting position, while the tongue conductive metal minor second abutting substructure is used to abut against each of the tongue minor bridging conductive terminals at a tongue conductive metal minor second abutting position, wherein the tongue conductive metal minor first abutting position and the tongue conductive metal minor second abutting position are different.

Preferably, the combined electrical connector said above, wherein the tongue insulation terminal frame major component comprises a tongue insulation terminal frame major assembly structure, and the tongue insulation terminal frame minor component includes a tongue insulation terminal frame minor assembly structure, wherein the tongue insulation terminal frame major assembly structure and the tongue insulation terminal frame minor assembly structure are structurally coordinated, allowing the tongue insulation terminal frame major component and the tongue insulation terminal frame minor component to be assembled into a tongue insulation terminal frame combination.

Preferably, the combined electrical connector said above, wherein the tongue base assembly structure, the tongue insulation terminal frame major assembly structure, and the tongue insulation terminal frame minor assembly structure are designed with a protrusion and recess structure which are structurally coordinated.

Preferably, the combined electrical connector said above, wherein the tongue insulation terminal frame combination includes a tongue insulation terminal frame joining structure, in the electrical connector combination, the tongue insulation terminal frame joining structure is joined with the outer shell component through a snap-in, fastening, or interference method.

Preferably, the combined electrical connector said above, wherein the tongue insulation terminal frame combination includes a tongue insulation terminal frame interior space; wherein the tongue conductive metal connection structure extends in the tongue insulation terminal frame interior space, wherein the tongue conductive metal major abutting structure abuts each of the tongue major bridging conductive terminals, and the tongue conductive metal minor abutting structure abuts each of the tongue minor bridging conductive terminals in the tongue insulation terminal frame interior space.

Preferably, the combined electrical connector said above, wherein the tongue base is an insulation base or a conductive base.

In comparison to prior art, the combined electrical connector provided in this application is at least composed of an outer shell component and a tongue component. The tongue component is at least composed of a tongue base, a tongue insulation terminal frame, a tongue bridging conductive metal, a tongue major conductive terminal assembly, and a tongue minor conductive terminal assembly. Therefore, after the electrical connector design is completed, customization and adjustment of the quantity, structure, and electrical connection relationship of the conductive terminals of the electrical connector can still be achieved by adjusting the outer shell component and the tongue component. This allows meeting the specific requirements and developments of electronic devices.

Additionally, the tongue bridging conductive metal can achieve electrical connection between certain conductive terminals of the electrical connector, reducing signal crosstalk between certain conductive terminals of the electrical connector to enhance the transmission speed and quality of signal of the electrical connector. Furthermore, this application eliminates the need for additional jumper adapters to achieve electrical connection between certain conductive terminals in the electrical connector to allow electronic devices equipped with the combined electrical connector disclosed in this application to continue evolving towards a direction of being lightweight, compact, and small.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a three-dimensional schematic diagram of the embodiment of the combined electrical connector in the present application.

FIG. 2 is a three-dimensional schematic diagram of the embodiment of the combined electrical connector in the present application.

FIG. 3 is a top view schematic diagram of some components of an embodiment of the combined electrical connector according to the present application.

FIG. 4 is a sectional schematic diagram of some components of the combined electrical connector shown in FIG. 3 cut along the line AA.

FIG. 5 is a sectional schematic diagram of some components of the combined electrical connector shown in FIG. 3 cut along the line BB.

FIG. 6 is a sectional schematic diagram of some components of the combined electrical connector shown in FIG. 3 cut along the line CC.

FIG. 7 is a side view schematic diagram of some components of an embodiment of the combined electrical connector according to the present application.

FIG. 8 is a bottom view schematic diagram of some components of an embodiment of the combined electrical connector according to the present application.

FIG. 9 is a three-dimensional schematic diagram of some components of an embodiment of the combined electrical connector according to the present application.

FIG. 10 is a three-dimensional schematic diagram of some components of an embodiment of the combined electrical connector according to the present application.

FIG. 11 is a three-dimensional schematic diagram of some components of an embodiment of the combined electrical connector according to the present application.

FIG. 12 is a three-dimensional schematic diagram of some components of an embodiment of the combined electrical connector according to the present application.

FIG. 13 is a three-dimensional schematic diagram of some components of an embodiment of the combined electrical connector according to the present application.

FIG. 14 is a three-dimensional schematic diagram of some components of an embodiment of the combined electrical connector according to the present application.

FIG. 15 is a three-dimensional schematic diagram of the embodiment of the combined electrical connector in the present application.

FIG. 16 is a three-dimensional schematic diagram of the embodiment of the combined electrical connector in the present application.

FIG. 17 is a top view schematic diagram of some components of an embodiment of the combined electrical connector according to the present application.

FIG. 18 is a sectional schematic diagram of some components of the combined electrical connector shown in FIG. 17 cut along the line DD.

FIG. 19 is a sectional schematic diagram of some components of the combined electrical connector shown in FIG. 17 cut along the line EE.

FIG. 20 is a sectional schematic diagram of some components of the combined electrical connector shown in FIG. 17 cut along the line FF.

FIG. 21 is a side view schematic diagram of some components of an embodiment of the combined electrical connector according to the present application.

FIG. 22 is a bottom view schematic diagram of some components of an embodiment of the combined electrical connector according to the present application.

FIG. 23 is a three-dimensional schematic diagram of some components of an embodiment of the combined electrical connector according to the present application.

FIG. 24 is a three-dimensional schematic diagram of some components of an embodiment of the combined electrical connector according to the present application.

FIG. 25 is a three-dimensional schematic diagram of some components of an embodiment of the combined electrical connector according to the present application.

FIG. 26 is a three-dimensional schematic diagram of some components of an embodiment of the combined electrical connector according to the present application.

FIG. 27 is a three-dimensional schematic diagram of some components of an embodiment of the combined electrical connector according to the present application.

FIG. 28 is a three-dimensional schematic diagram of some components of an embodiment of the combined electrical connector according to the present application.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

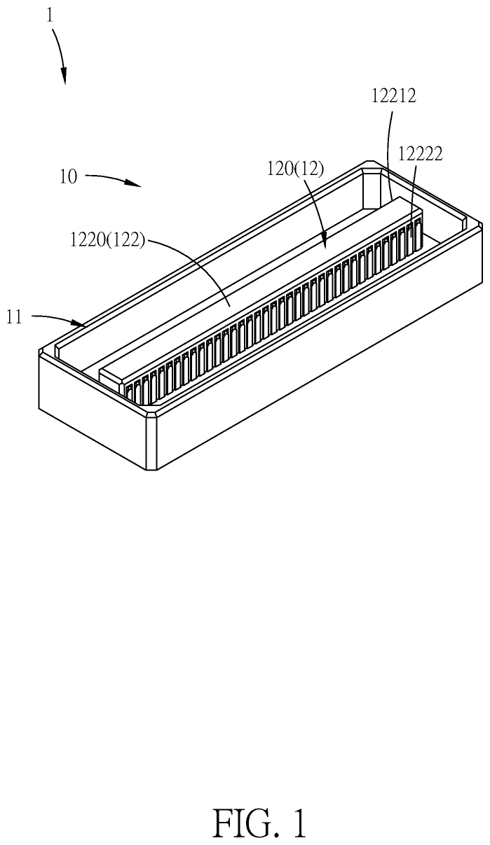

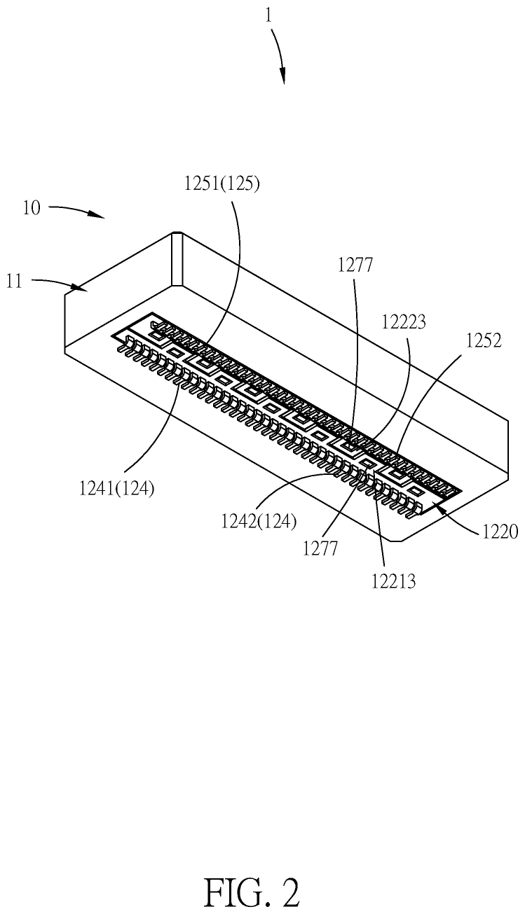

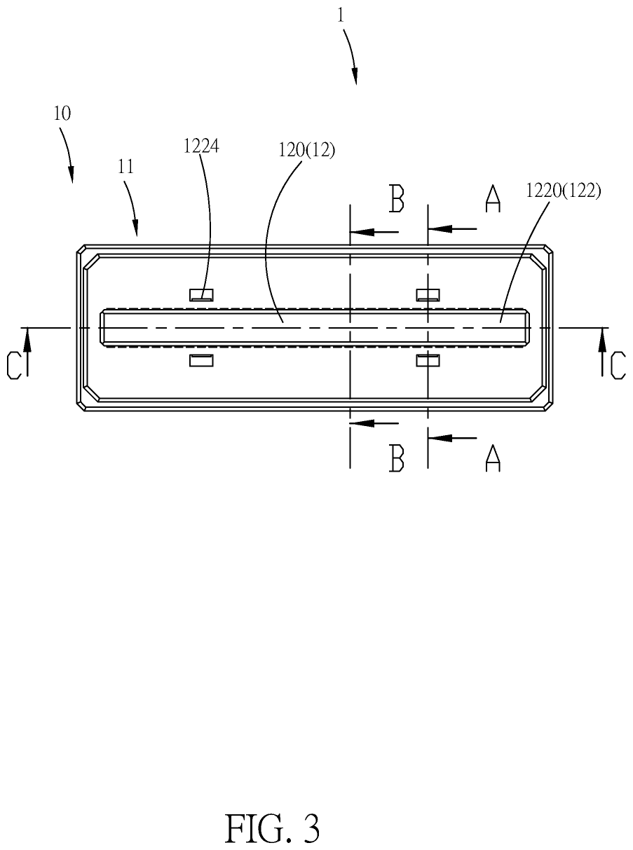

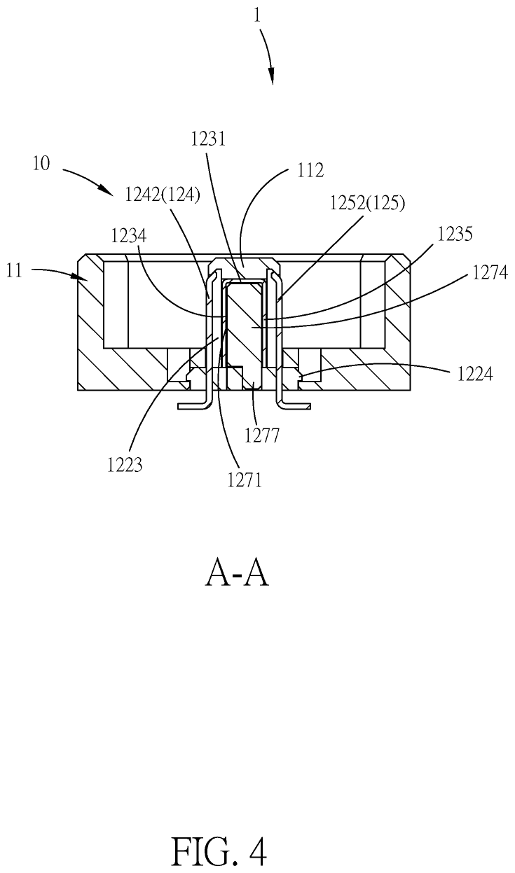

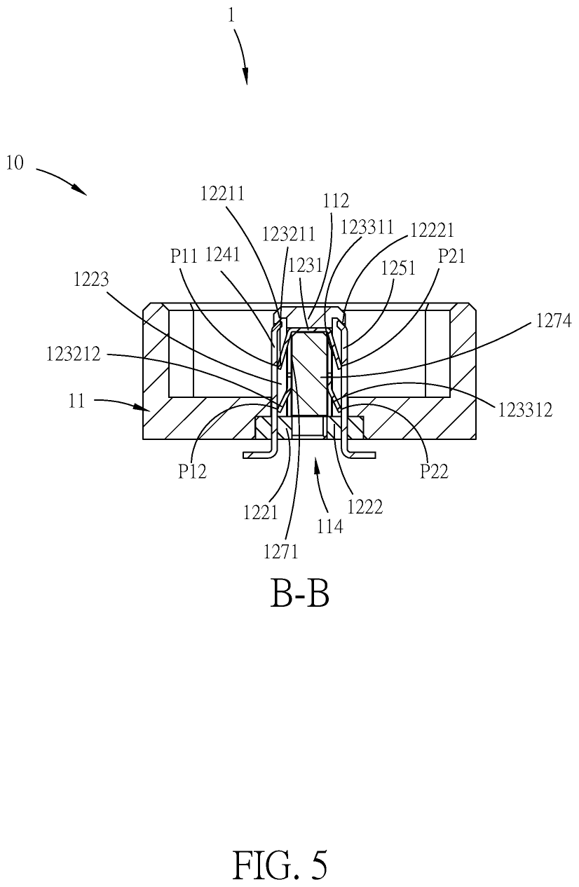

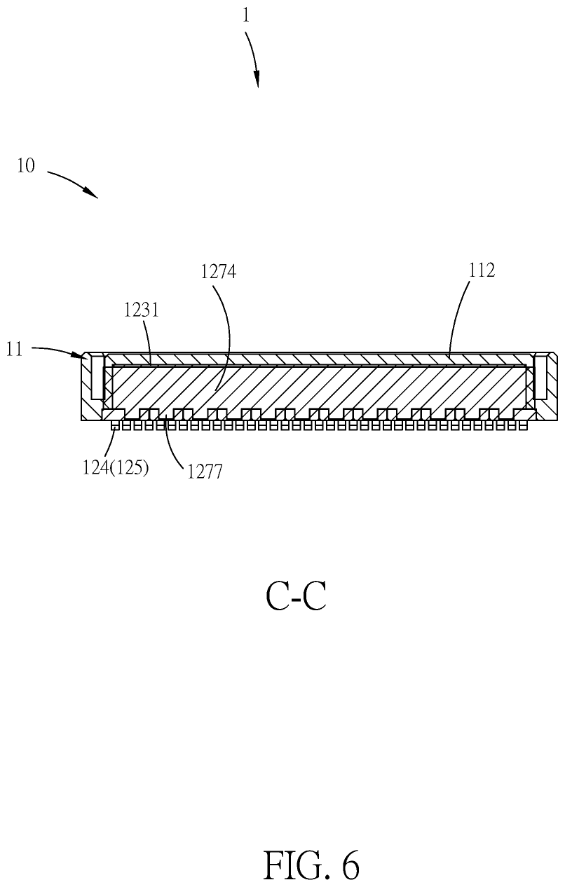

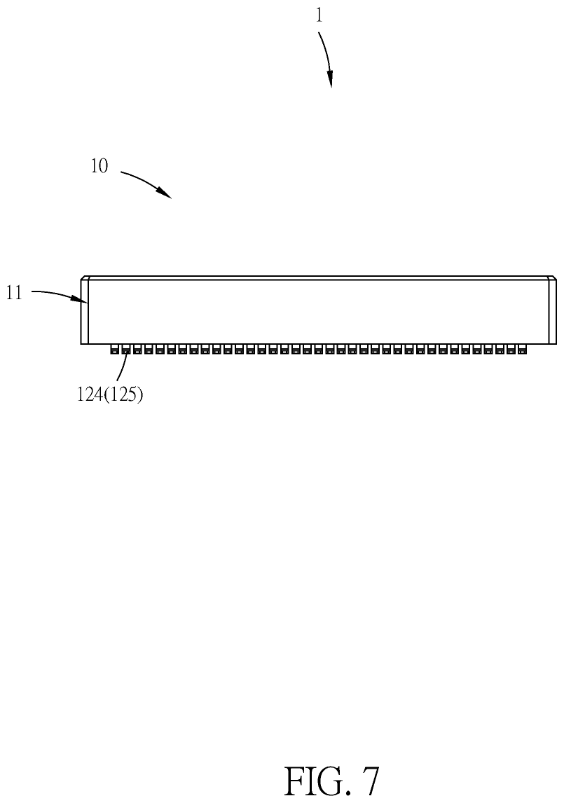

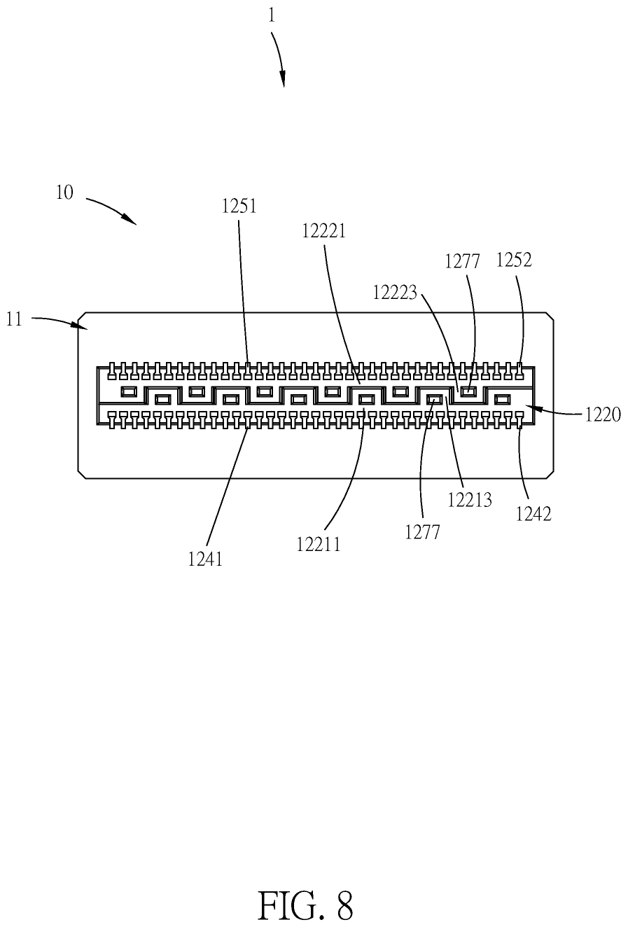

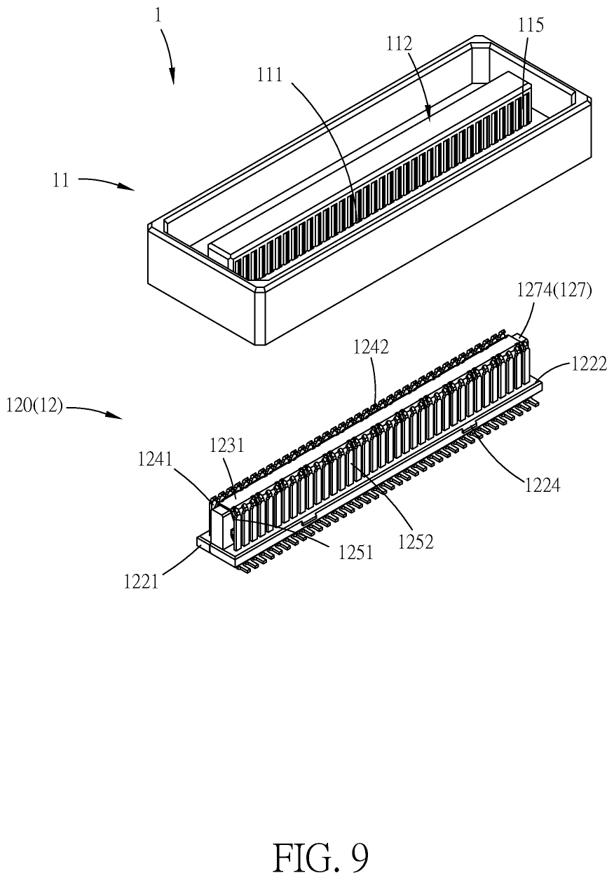

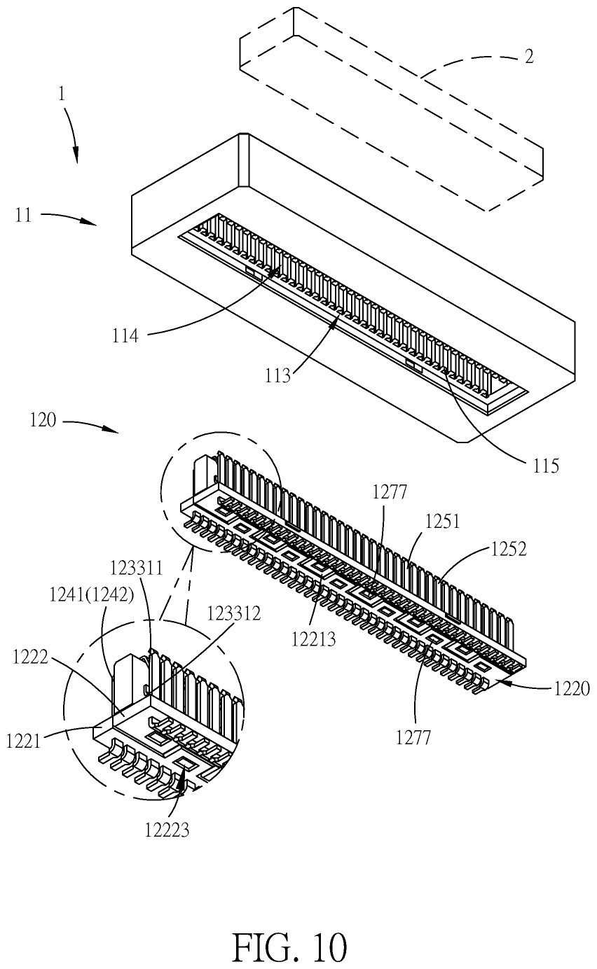

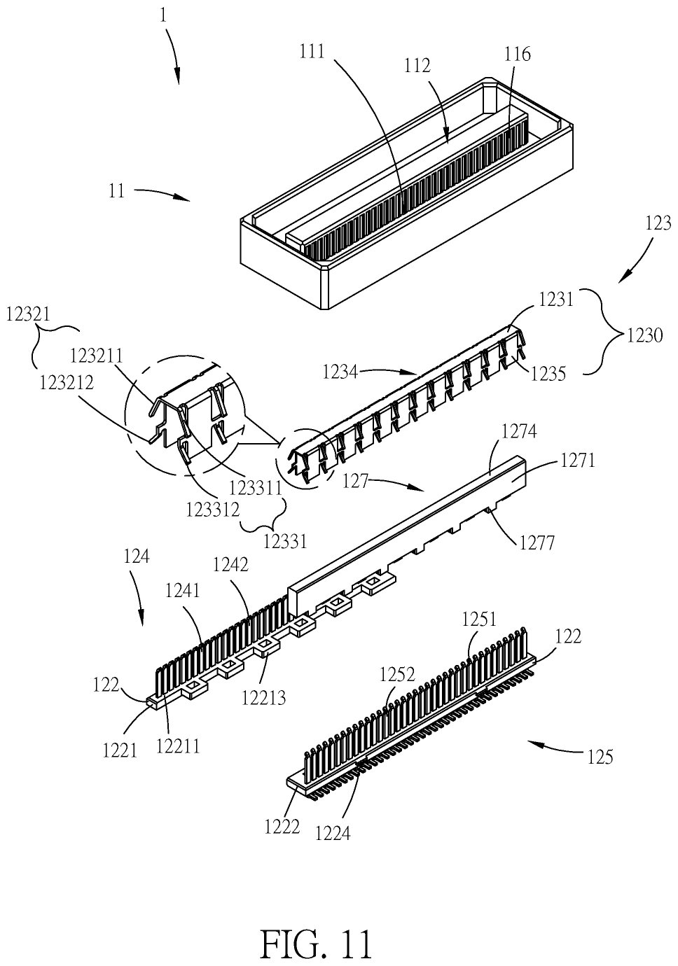

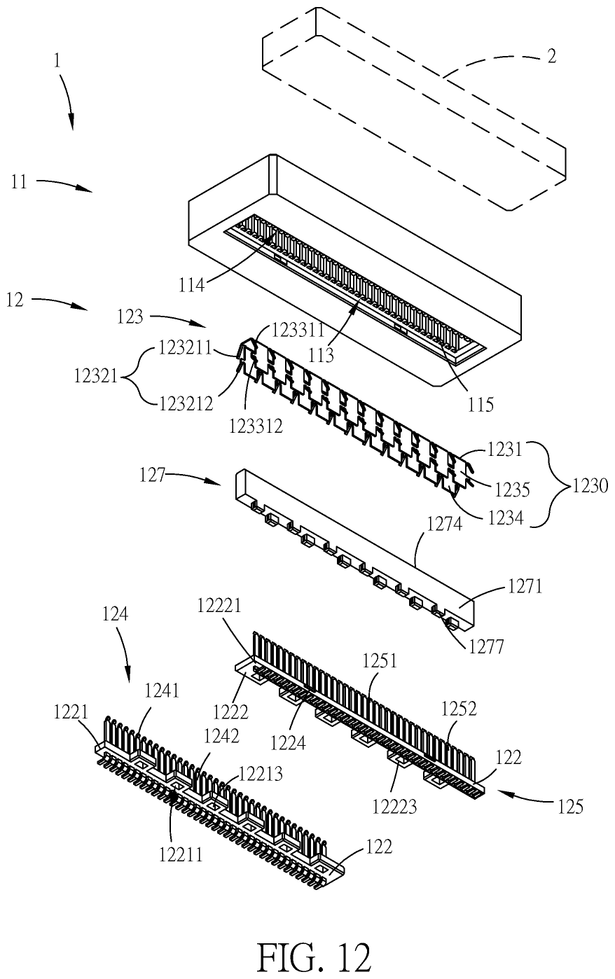

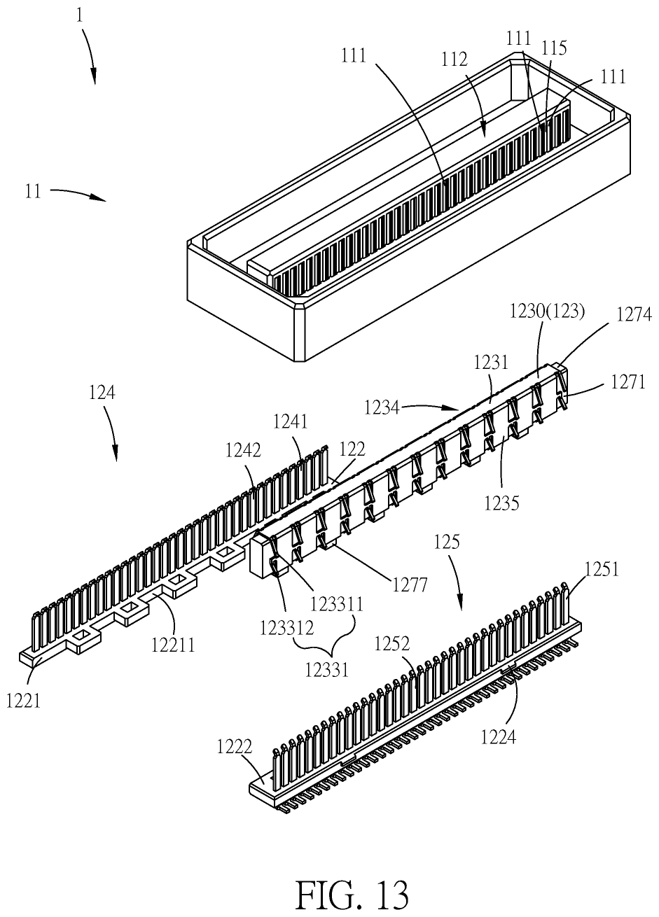

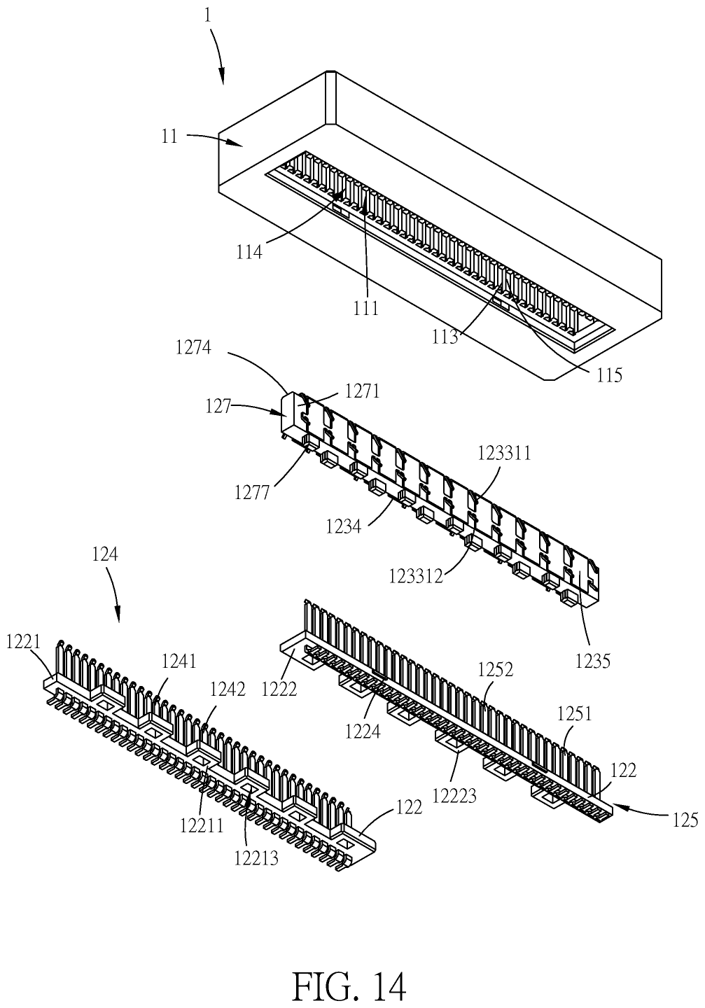

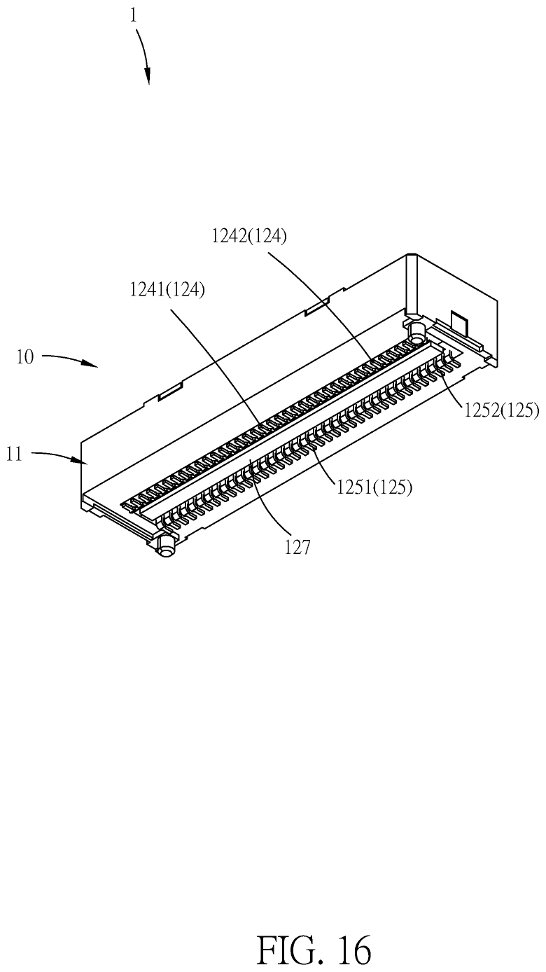

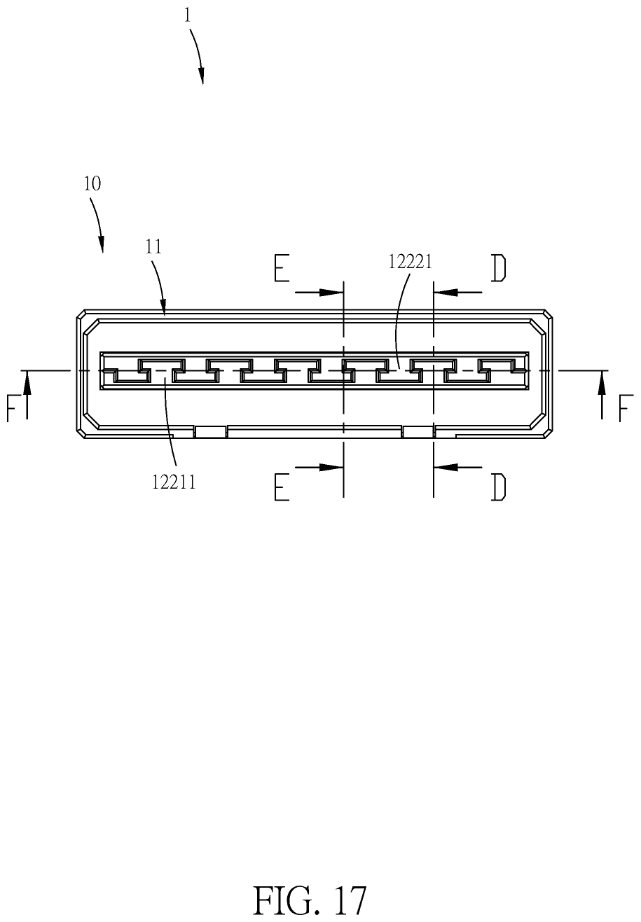

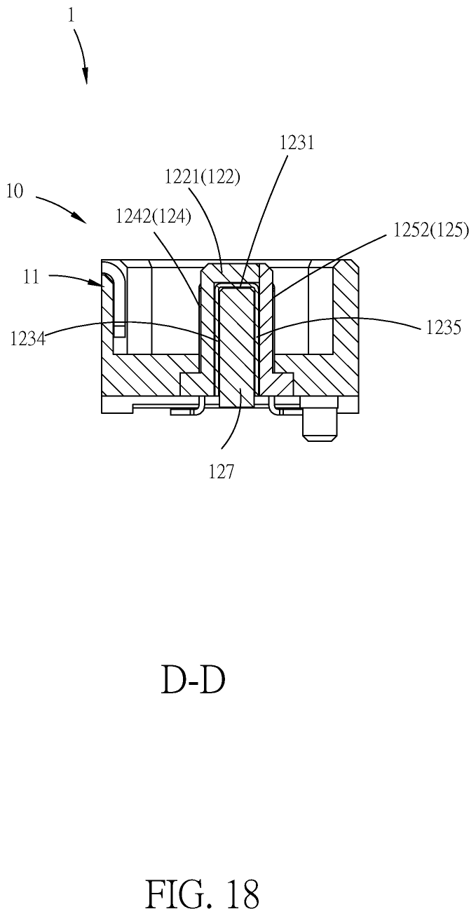

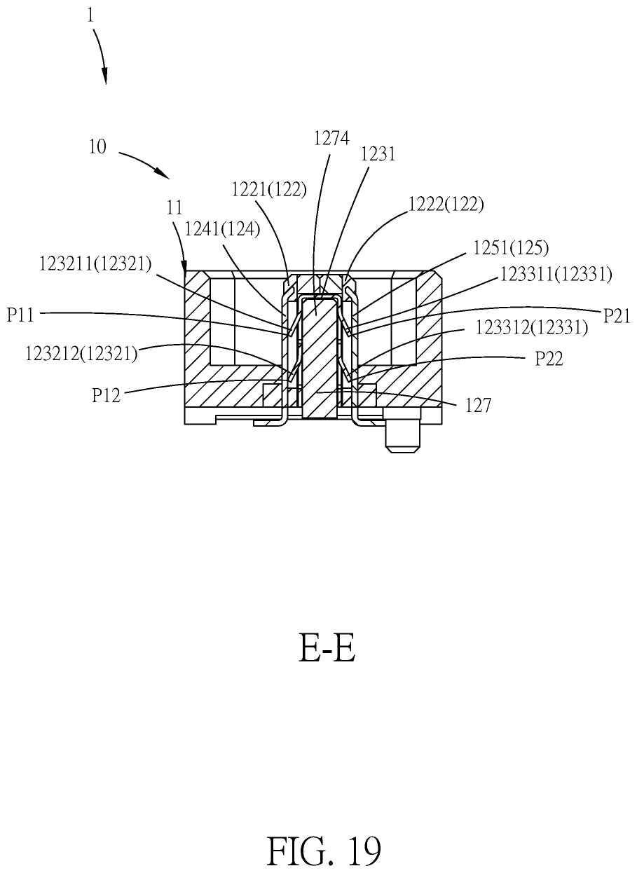

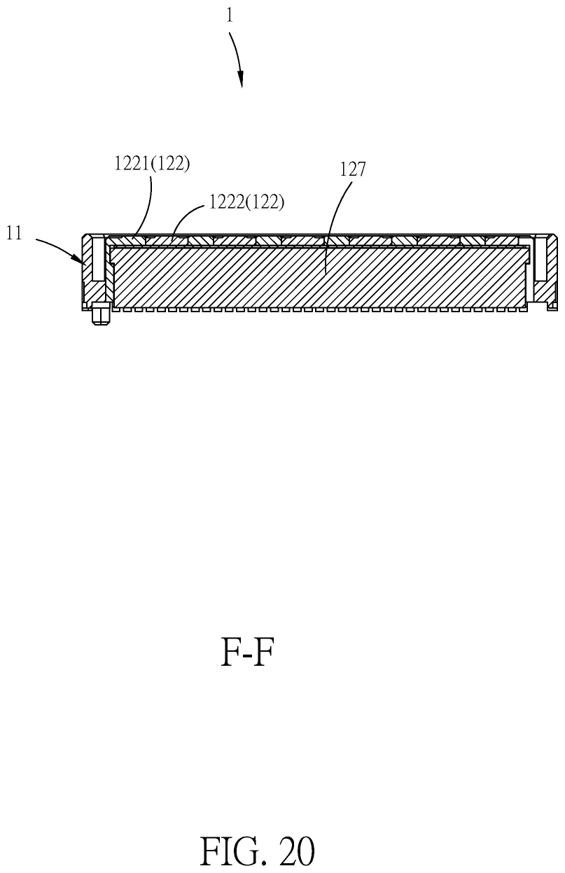

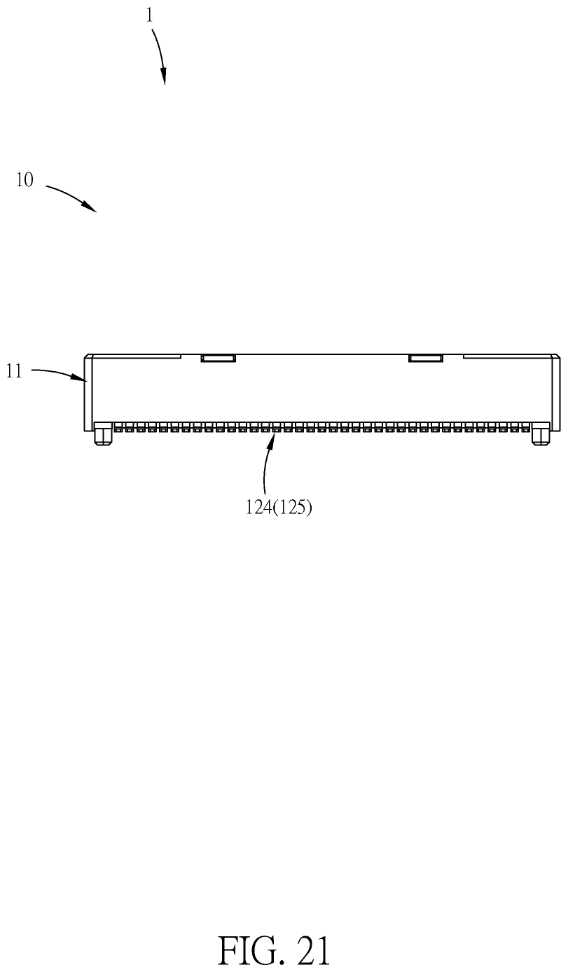

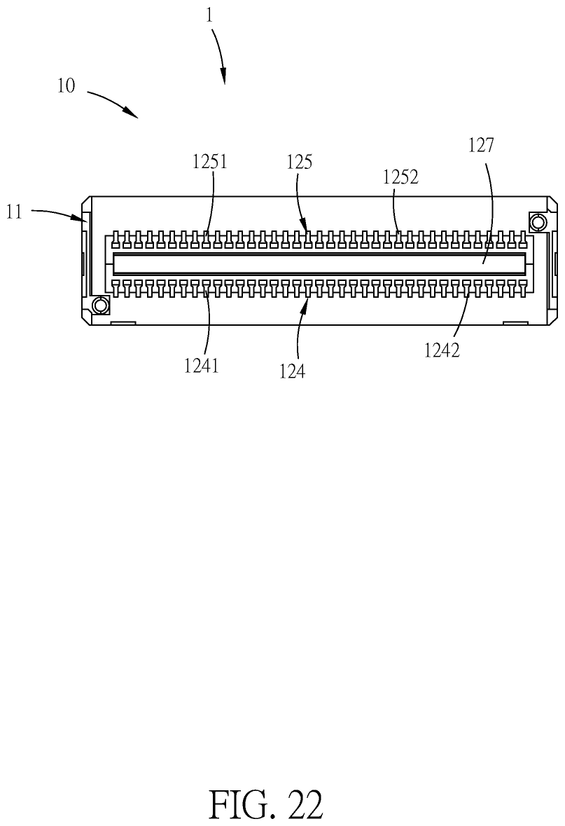

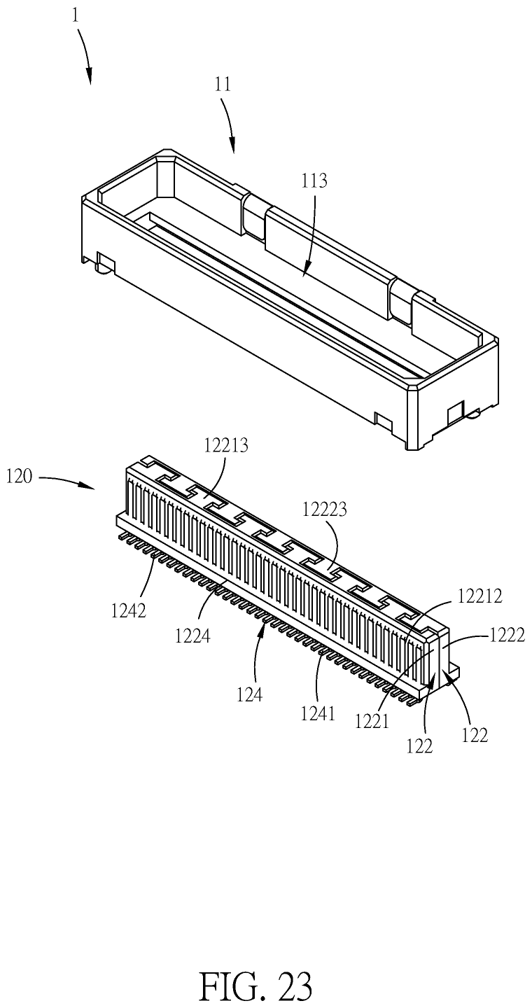

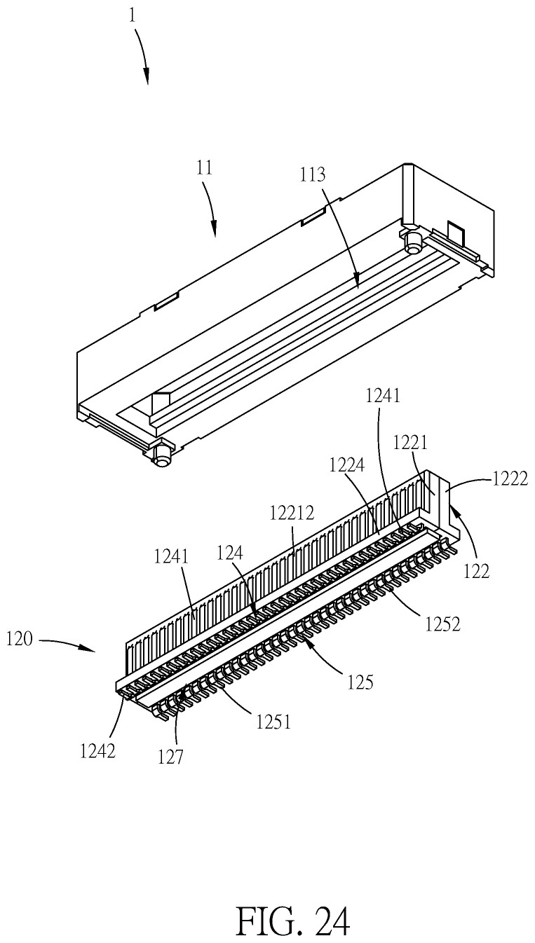

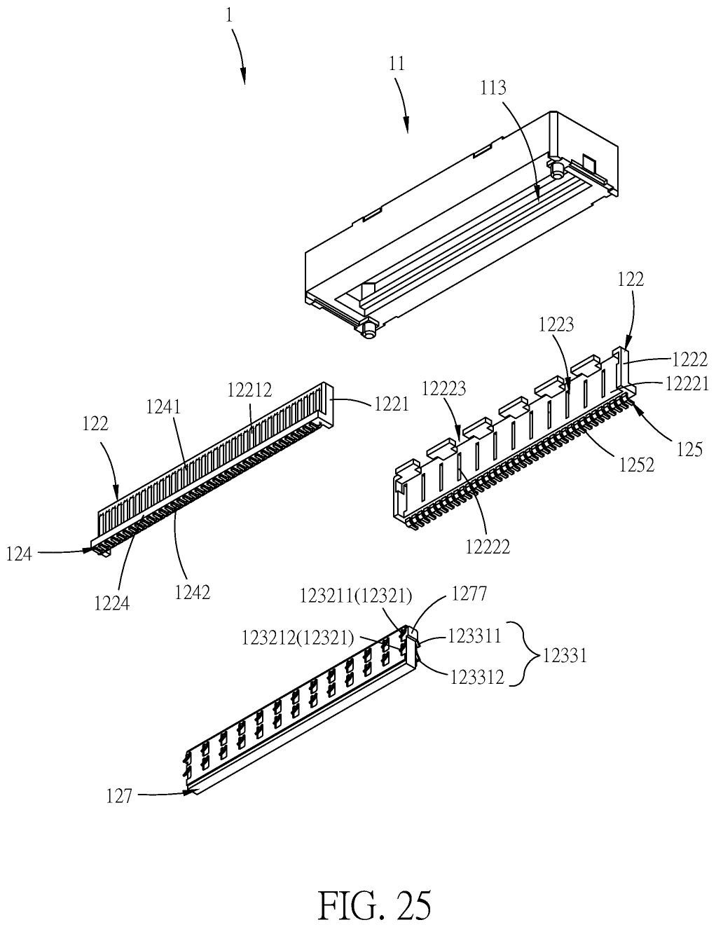

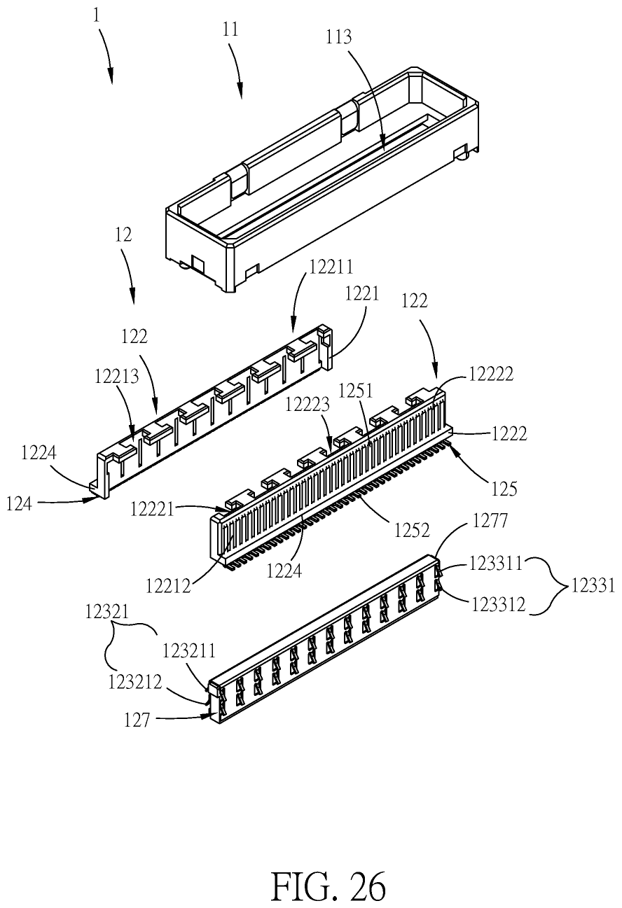

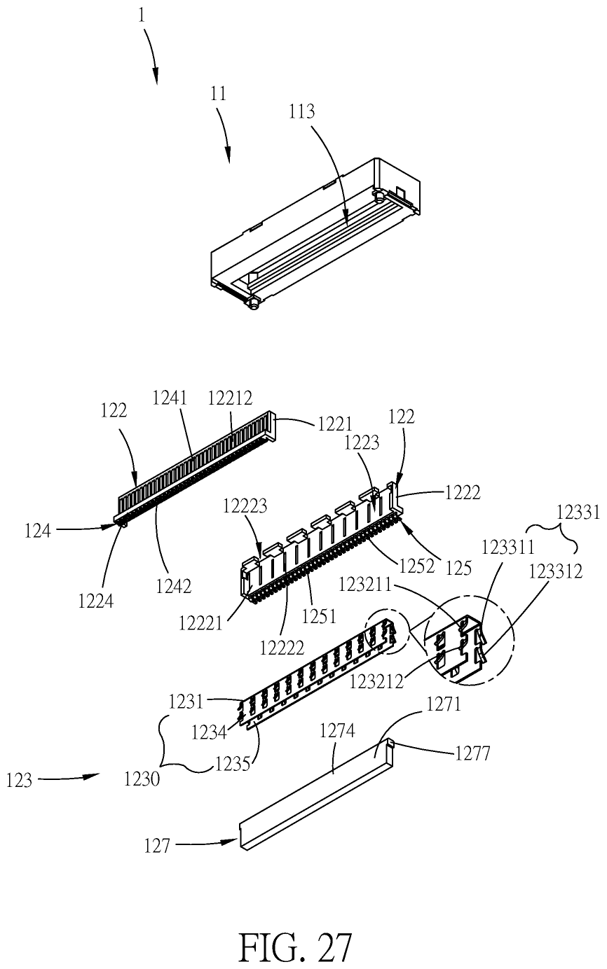

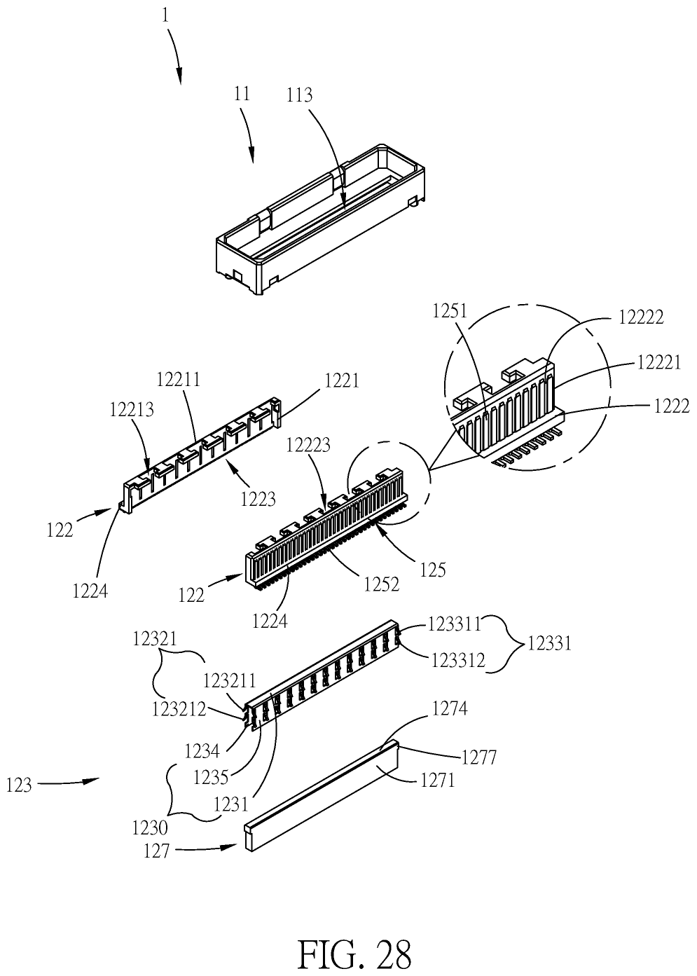

For a detailed description of the embodiments disclosed in the present application, please refer to FIGS. 1 to 28.

The present application provides a combined electrical connector that can be used for signal transmission in conjunction with a joining component. In the embodiments shown in FIGS. 1 to 14 of this application, the combined electrical connector 1 is a board end electrical connector installed on a circuit board to provide signal transmission, while the joining component 2 is a wire end electrical connector used for plugging into the board end electrical connector. The combined electrical connector 1 comprises an outer shell component 11 and a tongue component 12. The outer shell component 11, made of insulating material, serves to position the tongue component 12 and facilitate the joining with the joining component 2, while the tongue component 12 is designed for being equipped with the joining component 2.

In the embodiment said above, the outer shell component 11 includes an outer shell terminal joining port 111, an outer shell lingual structure 112, an outer shell bottom embedding port 113, an outer shell interior space 114, an outer shell component major separation structure 115, and an outer shell component minor separation structure 116. The outer shell lingual structure 112 provides to be equipped with the joining component 2. The outer shell bottom embedding port 113 is positioned at the bottom of the outer shell lingual structure 112. The outer shell interior space 114 is located within the outer shell lingual structure 112. The outer shell terminal joining port 111 is positioned on the side wall of the outer shell lingual structure 112.

In the embodiment said above, the tongue component 12 comprises a tongue base 127, a tongue insulation terminal frame 122, a tongue bridging conductive metal 123, a tongue major conductive terminal assembly 124, and a tongue minor conductive terminal assembly 125. The tongue major conductive terminal assembly 124 and the tongue minor conductive terminal assembly 125 can provide transmission of signal such as differential signal or ground signal. The tongue major conductive terminal assembly 124 has a plurality of tongue major bridging conductive terminals 1241 and tongue major non-bridging conductive terminals 1242. The tongue minor conductive terminal assembly 125 has a plurality of tongue minor bridging conductive terminals 1251 and tongue minor non-bridging conductive terminals 1252.

It should be noted that the plurality of tongue major bridging conductive terminals 1241 and tongue minor bridging conductive terminals 1251 can provide transmission of ground signal. Additionally, the number of the tongue major bridging conductive terminal 1241 and the tongue minor bridging conductive terminal 1251 is not limited to multiple; it does not preclude the possibility of having only one tongue major bridging conductive terminal 1241 and one tongue minor bridging conductive terminal 1251. Furthermore, the number of the tongue major non-bridging conductive terminal 1242 and the tongue minor non-bridging conductive terminal 1252 is not limited to one; it does not preclude the possibility of having multiple tongue major non-bridging conductive terminals 1242 and tongue minor non-bridging conductive terminals 1252.

In the embodiment said above, the tongue bridging conductive metal 123 comprises a tongue conductive metal connection structure 1231, a tongue conductive metal major abutting structure 12321, a tongue conductive metal minor abutting structure 12331, a tongue conductive metal major separation structure 1234, and a tongue conductive metal minor separation structure 1235. The tongue conductive metal connection structure 1231, the tongue conductive metal major separation structure 1234, and the tongue conductive metal minor separation structure 1235 are connected to form the tongue conductive metal structure 1230. The tongue conductive metal structure 1230 can be cut and bent from a metal sheet to form a structure with a U-shaped cross-section. The tongue conductive metal major abutting structure 12321 and the tongue conductive metal minor abutting structure 12331 can be formed by stamping the metal sheet, ensuring that the structural strength of the tongue conductive metal structure 1230 meets expectations.

It should be noted that, in the embodiment said above, the tongue conductive metal connection structure 1231, the tongue conductive metal major abutting structure 12321, the tongue conductive metal minor abutting structure 12331, the tongue conductive metal major separation structure 1234, and the tongue conductive metal minor separation structure 1235 are integrally formed as a unit. However, this is not limiting, and the tongue conductive metal connection structure 1231, the tongue conductive metal major abutting structure 12321, the tongue conductive metal minor abutting structure 12331, the tongue conductive metal major separation structure 1234, and the tongue conductive metal minor separation structure 1235 can be formed as separate components. In other words, the tongue bridging conductive metal 123 can be assembled from multiple components.

In the embodiment said above, the tongue base 127 includes a tongue base separation wall 1271 and a tongue base support structure 1274.

In the embodiment said above, the tongue insulation terminal frame 122 is made of insulating material and includes a tongue insulation terminal frame major component 1221 and a tongue insulation terminal frame minor component 1222. The tongue insulation terminal frame major component 1221 has a tongue insulation terminal frame major joining structure 12211 and a tongue insulation terminal frame major assembly structure 12213. The tongue insulation terminal frame minor component 1222 has a tongue insulation terminal frame minor joining structure 12221 and a tongue insulation terminal frame minor assembly structure 12223.

It should be noted that, in the embodiment said above, the tongue insulation terminal frame major component 1221 and the tongue insulation terminal frame minor component 1222 are designed as different components, but this is not limiting. The tongue insulation terminal frame major component 1221 and the tongue insulation terminal frame minor component 1222 can be designed to be integrated into a single unit.

In the embodiment said above, the tongue insulation terminal frame major joining structure 12211 and the tongue insulation terminal frame minor joining structure 12221 are respectively joined to one side of the tongue major conductive terminal assembly 124 and the tongue minor conductive terminal assembly 125 to provide positioning for the tongue major conductive terminal assembly 124 and the tongue minor conductive terminal assembly 125, allowing the tongue major conductive terminal assembly 124 and the tongue minor conductive terminal assembly 125 to form a cantilever structure. The cantilever structure is employed to ensure that the electrical characteristics of the combined electrical connector 1 meet the expectations.

The tongue insulation terminal frame major assembly structure 12213 and the tongue insulation terminal frame minor assembly structure 12223 are structurally coordinated, allowing the tongue insulation terminal frame major component 1221 and the tongue insulation terminal frame minor component 1222 to be assembled into a single unit to form the tongue insulation terminal frame combination 1220. Correspondingly, the tongue base 127 has a tongue base assembly structure 1277. The tongue base assembly structure 1277 is structurally coordinated with the tongue insulation terminal frame major assembly structure 12213 and the tongue insulation terminal frame minor assembly structure 12223 to enable the tongue insulation terminal frame major component 1221 and the tongue insulation terminal frame minor component 1222 to be assembled into a single unit, forming the tongue insulation terminal frame combination 1220.

It should be noted that, in the embodiment said above, the tongue base assembly structure 1277, the tongue insulation terminal frame major assembly structure 12213, and the tongue insulation terminal frame minor assembly structure 12223 are structurally coordinated as complementary protrusion and recess structure to reduce the thickness dimension of the tongue insulation terminal frame combination 1220, allowing the size of the combined electrical connector 1 of the present application to decrease, allowing electronic devices using the combined electrical connector 1 of the present application to continue developing in the direction of being lightweight, compact, and small in size.

In addition, the tongue base 127, the tongue insulation terminal frame 122, the tongue bridging conductive metal 123, the tongue major conductive terminal assembly 124, and the tongue minor conductive terminal assembly 125 are assembled to form the tongue component combination 120. In the tongue component combination 120, the tongue base separation wall 1271 separates the tongue major conductive terminal assembly 124 and the tongue minor conductive terminal assembly 125 The tongue base support structure 1274 provides support for the tongue conductive metal connection structure 1231, allowing the tongue conductive metal connection structure 1231 to span across or abut against the tongue base separation wall 1271 to allow the tongue conductive metal connection structure 1231 to extend over and respectively span across the tongue major non-bridging conductive terminal 1242 and the tongue minor non-bridging conductive terminal 1252. This results in the electrical connection of the tongue conductive metal connection structure 1231 to the tongue conductive metal major abutting structure 12321 and the tongue conductive metal minor abutting structure 12331, allowing the tongue conductive metal major abutting structure 12321 and the tongue conductive metal minor abutting structure 12331 to form a bridging circuit capable of transmitting ground signal.

Furthermore, in the tongue component combination 120, the tongue conductive metal major abutting structure 12321 is abutted to each of the tongue major bridging conductive terminals 1241. Additionally, the tongue conductive metal minor abutting structure 12331 is abutted to each of the tongue minor bridging conductive terminals 1251. This allows the electrical connection of each of the tongue major bridging conductive terminals 1241 and each of the tongue minor bridging conductive terminals 1251 to form a bridging circuit capable of transmitting ground signal.

It should be noted that the combined electrical connector 1 of the present application achieves electrical connection between the conductive terminals of the electrical connector, eliminating the need for additional jumper adapters for electrical connection between the conductive terminals of the electrical connector. This allows electronic devices using the combined electrical connector 1 of the present application to continue developing in the direction of being lightweight, compact, and small. Additionally, the bridging circuit provides transmission of ground signal, enabling to reduce signal interference between the conductive terminals of the electrical connector and optimizing the transmission speed and quality of signal, meeting the specific needs and development requirements of electronic devices.

It should be noted that, in the embodiment said above, the tongue component 120 is formed by the combination of the tongue base 127, the tongue insulation terminal frame 122, the tongue bridging conductive metal 123, the tongue major conductive terminal assembly 124, and the tongue minor conductive terminal assembly 125. Therefore, after the electrical connector is designed, customization can still be achieved by separately adjusting the tongue base 127, the tongue insulation terminal frame 122, the tongue bridging conductive metal 123, the tongue major conductive terminal assembly 124, and the tongue minor conductive terminal assembly 125. This allows for the customized adjustment of the quantity, structure, and electrical connection relationships of the conductive terminals of the electrical connector to meet the specific needs and development of electronic devices.

In the embodiment said above, the tongue conductive metal major abutting structure 12321 comprises a tongue conductive metal major first abutting substructure 123211 and a tongue conductive metal major second abutting substructure 123212. The tongue conductive metal major first abutting substructure 123211 is designed to abut each of the tongue major bridging conductive terminals 1241 at the tongue conductive metal major first abutting site P11, and the tongue conductive metal major second abutting substructure 123212 is intended to abut each of the tongue major bridging conductive terminals 1241 at the tongue conductive metal major second abutting site P12. Notably, the tongue conductive metal major first abutting site P11 and the tongue conductive metal major second abutting site P12 are distinct to ensure that the tongue conductive metal major abutting structure 12321 abuts each of the tongue major bridging conductive terminals 1241 at both sites, thereby ensuring that the tongue bridging conductive metal 123 can abut each of the tongue major bridging conductive terminals 1241 to form a bridging circuit that provides a transmission for ground signal.

Additionally, the tongue conductive metal minor abutting structure 12331 comprises a tongue conductive metal minor first abutting substructure 123311 and a tongue conductive metal minor second abutting substructure 123312. The tongue conductive metal minor first abutting substructure 123311 is designed to abut each of the tongue minor bridging conductive terminals 1251 at the tongue conductive metal minor first abutting site P21, and the tongue conductive metal minor second abutting substructure 123312 is intended to abut each of the tongue minor bridging conductive terminals 1251 at the tongue conductive metal minor second abutting site P22. Notably, the tongue conductive metal minor first abutting site P21 and the tongue conductive metal minor second abutting site P22 are distinct to ensure that the tongue conductive metal minor abutting structure 12331 abuts each of the tongue minor bridging conductive terminals 1251 at both positions, thereby ensuring that the tongue bridging conductive metal 123 can abut each of the tongue minor bridging conductive terminals 1251 to form a bridging circuit that provides a transmission for ground signal.

In the embodiment said above, the tongue conductive metal major abutting structure 12321 is designed as a cantilever structure, allowing the tongue bridging conductive metal 123 to flexibly abut each of the tongue major bridging conductive terminals 1241, resulting in the tongue conductive metal major abutting structure 12321 achieving a better abutment with each of the tongue major bridging conductive terminals 1241. Similarly, the tongue conductive metal minor abutting structure 12331 is designed as a cantilever structure, enabling the tongue bridging conductive metal 123 to flexibly abut each of the tongue minor bridging conductive terminals 1251, resulting in the tongue conductive metal minor abutting structure 12331 achieving a better abutment with each of the tongue minor bridging conductive terminals 1251.

Furthermore, the tongue conductive metal major separation structure 1234 extends along the tongue base separation wall 1271 and crosses over the tongue major non-bridging conductive terminal 1242 to separate the tongue major non-bridging conductive terminal 1242 from the tongue minor conductive terminal assembly 125, reducing the signal crosstalk between the tongue major non-bridging conductive terminal 1242 and the tongue minor conductive terminal assembly 125, thereby enabling to reduce signal crosstalk and optimize the transmission speed and quality of the connector for specific electronic device requirements and development. The tongue conductive metal minor separation structure 1235 extends along the tongue base separation wall 1271 and crosses over the tongue minor non-bridging conductive terminal 1252 to separate the tongue major conductive terminal assembly 124 from the tongue minor non-bridging conductive terminal 1252, reducing signal crosstalk of the tongue major conductive terminal assembly 124 from the tongue minor non-bridging conductive terminal 1252 and optimizing the transmission speed and quality of the connector for specific electronic device requirements and development.

In addition, the tongue base 127 can be a conductive plastic base to separate the tongue major conductive terminal assembly 124 and the tongue minor conductive terminal assembly 125 through the conductive plastic base, however, further enabling to reducing the signal crosstalk of the tongue major conductive terminal assembly 124 and the tongue minor conductive terminal assembly 125, optimizing the transmission speed and quality of the connector for specific electronic device requirements and development. However, it is not to be limited, the tongue base 127 can be an insulation base to provide support to the tongue bridging conductive metal 123 via the insulation base.

In the above embodiment, the tongue component 12 can enter the outer shell interior space 114 through the outer shell bottom embedding port 113 and is embedded in the outer shell component 11 to form the electrical connector combination 10. It should be noted that in the electrical connector combination 10, the joining portion of the tongue major conductive terminal assembly 124 and the tongue minor conductive terminal assembly 125 is exposed on the outer shell terminal joining port 111. When the outer shell component 11 is joined with the joining component 2, the joining portion of the tongue major conductive terminal assembly 124 and the tongue minor conductive terminal assembly 125 electrically joins with the joining component 2 to provide signal transmission.

Furthermore, the outer shell component major separation structure 115, for example, is in the form of a fence-like structure to separate adjacent two of the plurality of the tongue major bridging conductive terminals 1241 and the tongue major non-bridging conductive terminals 1242 to prevent electrical short circuits between adjacent of the plurality of the tongue major bridging conductive terminals 1241 and tongue major non-bridging conductive terminals 1242 and provides protection for the plurality of the tongue major bridging conductive terminals 1241 and the tongue major non-bridging conductive terminals 1242. The outer shell component minor separation structure 116, for example, is in the form of a fence-like structure to separate adjacent two of the plurality of the he tongue minor bridging conductive terminals 1251 and the tongue minor non-bridging conductive terminals 1252 to prevent electrical short circuits between adjacent two of the plurality of the tongue minor bridging conductive terminals 1251 and the tongue minor non-bridging conductive terminals 1252 and provides protection for the plurality of the tongue minor bridging conductive terminals 1251 and the tongue minor non-bridging conductive terminals 1252.

In the embodiment said above, the tongue insulation terminal frame 122 includes a tongue insulation terminal frame joining structure 1224. In the electrical connector combination 10, the tongue insulation terminal frame joining structure 1224 is joined with the outer shell component 11 through a snapping, fastening, or interference method, allowing the tongue insulation terminal frame 122 to be integrally joined with the outer shell component 11. Therefore, the tongue insulation terminal frame joining structure 1224 functions as a snapping structure, fastening structure, or interference structure.

It should be noted that in the embodiment said above, certain components mentioned earlier can be omitted. For example, in this application, the combined electrical connector includes an outer shell component and a tongue component. The outer shell component provides to be joined with the joining component and includes an outer shell terminal joining port. The tongue component comprises a tongue base, a tongue insulation terminal frame, a tongue bridging conductive metal, a tongue major conductive terminal assembly, and a tongue minor conductive terminal assembly. The tongue major conductive terminal assembly includes the plurality of the tongue major bridging conductive terminals and the tongue major non-bridging conductive terminals. The tongue minor conductive terminal assembly includes a plurality of tongue minor bridging conductive terminals and tongue minor non-bridging conductive terminals. The tongue bridging conductive metal includes a tongue conductive metal connection structure, a tongue conductive metal major abutting structure, and a tongue conductive metal minor abutting structure. The tongue base includes a tongue base separation wall. The tongue insulation terminal frame includes a tongue insulation terminal frame major joining structure and a tongue insulation terminal frame minor joining structure. The tongue insulation terminal frame major joining structure and the tongue insulation terminal frame minor joining structure are joined with one side of the tongue major conductive terminal assembly and the tongue minor conductive terminal assembly, respectively, providing positioning for the tongue major conductive terminal assembly and the tongue minor conductive terminal assembly. The tongue base, the tongue insulation terminal frame, the tongue bridging conductive metal, the tongue major conductive terminal assembly, and the tongue minor conductive terminal assembly are combined to form the tongue component combination. In the tongue component assembly, the tongue base separation wall separates the tongue major conductive terminal assembly and the tongue minor conductive terminal assembly. The tongue conductive metal connection structure extends and respectively crosses over the tongue major non-bridging conductive terminals and the tongue minor non-bridging conductive terminals, allowing the tongue conductive metal connection structure to respectively electrically connect with the tongue conductive metal major abutting structure and the tongue conductive metal minor abutting structure. The tongue conductive metal major abutting structure abuts each of the tongue major bridging conductive terminals, and the tongue conductive metal minor abutting structure abuts each of the tongue minor bridging conductive terminals, allowing each of the tongue major bridging conductive terminals and each of the tongue minor bridging conductive terminals to be electrically connected. The tongue component is embedded in the outer shell component to form an electrical connector combination. In the electrical connector combination, the joining portion of the tongue major conductive terminal assembly and the tongue minor conductive terminal assembly expose on the outer shell terminal joining port. When the outer shell component is joined with the joining component, the joining portion of the tongue major conductive terminal assembly and the tongue minor conductive terminal assembly electrically join with the joining component.

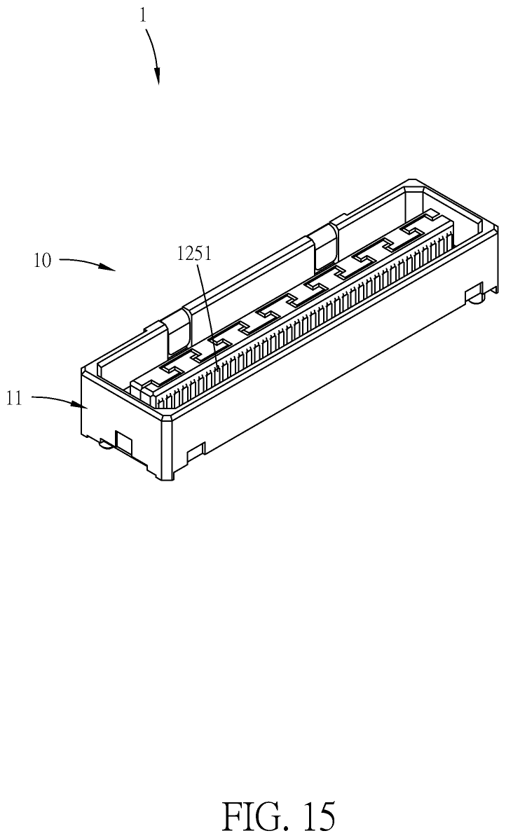

This application provides a combined electrical connector that can be used for signal transmission in joining with a joining component. In the embodiments shown in FIGS. 15 to 28 of this application, the combined electrical connector 1 is a board-end electrical connector installed on a circuit board to facilitate signal transmission. The joining component 2 is a wire-end electrical connector used for plugging into the board-end electrical connector. The combined electrical connector 1 includes an outer shell component 11 and a tongue component 12. The outer shell component 11 made of insulation material, serves to position the tongue component 12 and provides to be joined with the joining component 2. The tongue component 12 is designed to be joined with the joining component 2.

In the embodiment said above, the outer shell component 11 includes an outer shell bottom embedding port 113, wherein the outer shell bottom embedding port 113 is equipped at the bottom of the outer shell component 11.

In the embodiment said above, the tongue component 12 has a tongue base 127, a tongue insulation terminal frame 122, a tongue bridging conductive metal 123, a tongue major conductive terminal assembly 124, and a tongue minor conductive terminal assembly 125. The tongue major conductive terminal assembly 124 and the tongue minor conductive terminal assembly 125 can provide transmission, such as differential signal or ground signal. The tongue major conductive terminal assembly 124 has a plurality of tongue major bridging conductive terminals 1241 and tongue major non-bridging conductive terminals 1242. The tongue minor conductive terminal assembly 125 has a plurality of tongue minor bridging conductive terminals 1251 and tongue minor non-bridging conductive terminals 1252.

It should be noted that the plurality of the tongue major bridging conductive terminals 1241 and the tongue minor bridging conductive terminals 1251 can provide the transmission of the ground signal. Additionally, the placement quantity of the tongue major bridging conductive terminal 1241 and the tongue minor bridging conductive terminal 1251 are not limited to multiple, and the placement quantity of the tongue major bridging conductive terminals 1241 and the tongue minor bridging conductive terminals 1251 is possible to be one. Additionally, the placement quantity of the tongue major non-bridging conductive terminals 1242 and the tongue minor non-bridging conductive terminals 1252 is not limited to one; it is possible to have plurality of tongue major non-bridging conductive terminals 1242 and the tongue minor non-bridging conductive terminals 1252.

In the embodiment said above, the tongue bridging conductive metal 123 comprises a tongue conductive metal connection structure 1231, a tongue conductive metal major abutting structure 12321, a tongue conductive metal minor abutting structure 12331, a tongue conductive metal major separation structure 1234, and a tongue conductive metal minor separation structure 1235. The tongue conductive metal connection structure 1231, the tongue conductive metal major separation structure 1234, and the tongue conductive metal minor separation structure 1235 are connected to form the tongue conductive metal structure 1230. The tongue conductive metal structure 1230 can be cut and bent from a metal sheet to form a structure with a U-shaped cross-section. The tongue conductive metal major abutting structure 12321 and the tongue conductive metal minor abutting structure 12331 can be formed by stamping the metal sheet to ensure that the structural strength of the tongue conductive metal structure 1230 meets expectations.

It should be noted that in the embodiment said above, the tongue conductive metal connection structure 1231, the tongue conductive metal major abutting structure 12321, the tongue conductive metal minor abutting structure 12331, the tongue conductive metal major separation structure 1234, and the tongue conductive metal minor separation structure 1235 form as a single unit, but it is not limited, the tongue conductive metal connection structure 1231, the tongue conductive metal major abutting structure 12321, the tongue conductive metal minor abutting structure 12331, the tongue conductive metal major separation structure 1234, and the tongue conductive metal minor separation structure 1235 can form as different components, in other words, the tongue bridging conductive metal 123 can be composed of multiple components.

In the embodiment said above, the tongue base 127 includes a tongue base separation wall 1271 and the tongue base support structure 1274.

In the embodiment said above, the tongue insulation terminal frame 122 is made of insulating material and comprises a tongue insulation terminal frame major component 1221 and a tongue insulation terminal frame minor component 1222. The tongue insulation terminal frame major component 1221 has a tongue insulation terminal frame major joining structure 12211 and a tongue insulation terminal frame major assembly structure 12213. The tongue insulation terminal frame minor component 1222 has a tongue insulation terminal frame minor joining structure 12221 and a tongue insulation terminal frame minor assembly structure 12223.

It should be noted that in the embodiment said above, the tongue insulation terminal frame major component 1221 and the tongue insulation terminal frame minor component 1222 are different component, but it is not limited, the tongue insulation terminal frame major component 1221 and the tongue insulation terminal frame minor component 1222 can be designed to form as a single unit.

In the embodiment said above, the tongue insulation terminal frame major joining structure 12211 and the tongue insulation terminal frame minor joining structure 12221 are respectively joined to the opposite sides of the tongue major conductive terminal assembly 124 and the tongue minor conductive terminal assembly 125 to respectively provide positioning for both the tongue major conductive terminal assembly 124 and the tongue minor conductive terminal assembly 125, ensuring that the electrical characteristics of the combined electrical connector 1 meet the expectations.

The tongue insulation terminal frame major assembly structure 12213 and the tongue insulation terminal frame minor assembly structure 12223 are structurally coordinated, allowing the tongue insulation terminal frame major component 1221 and the tongue insulation terminal frame minor component 1222 to be assembled into a single unit to form the tongue insulation terminal frame combination 1220. Correspondingly, the tongue base 127 has a tongue base assembly structure 1277. The tongue base assembly structure 1277 is structurally coordinated with the tongue insulation terminal frame major assembly structure 12213 and the tongue insulation terminal frame minor assembly structure 12223 to enable the tongue insulation terminal frame major component 1221 and the tongue insulation terminal frame minor component 1222 to be assembled into a single unit, forming the tongue insulation terminal frame combination 1220.

In the embodiment said above, the tongue insulation terminal frame major assembly structure 12213 or tongue insulation terminal frame minor assembly structure 12223 is a columnar structure designed to avoid the tongue bridging conductive metal 123 and pass through the tongue base 127. Correspondingly, the tongue base assembly structure 1277 is configured as a through-hole structure.

It should be noted that, in the embodiment said above, the tongue base assembly structure 1277, the tongue insulation terminal frame major assembly structure 12213, and the tongue insulation terminal frame minor assembly structure 12223 are structurally coordinated as complementary protrusion and recess structure to reduce the thickness dimension of the tongue insulation terminal frame combination 1220, allowing the size of the combined electrical connector 1 of the present application to decrease, allowing electronic devices using the combined electrical connector 1 of the present application to continue developing in the direction of being lightweight, compact, and small in size.

In addition, the tongue base 127, the tongue insulation terminal frame major component 1221, the tongue insulation terminal frame minor component 1222, the tongue bridging conductive metal 123, the tongue major conductive terminal assembly 124, and the tongue minor conductive terminal assembly 125 are combined to form a tongue component combination 120. In the tongue component combination 120, the tongue base separation wall 1271 separates the tongue major conductive terminal assembly 124 from the tongue minor conductive terminal assembly 125. The tongue base support structure 1274 provides support to the tongue conductive metal connection structure 1231, allowing the tongue conductive metal connection structure 1231 to span or abut against the tongue base separation wall 1271 to allowing the tongue conductive metal connection structure 1231 to extend over and respectively bridge across tongue major non-bridging conductive terminal 1242 and the tongue minor non-bridging conductive terminal 1252, enabling the tongue conductive metal connection structure 1231 to electrically connect with the tongue bridging conductive metal major abutting structure 12321 and the tongue bridging conductive metal minor abutting structure 12331, forming a bridging circuit that can transmit ground signal.

Furthermore, in the tongue component combination 120, the tongue conductive metal major abutting structure 12321 is abutted to each of the tongue major bridging conductive terminals 1241. Additionally, the tongue conductive metal minor abutting structure 12331 is abutted to each of the tongue minor bridging conductive terminals 1251 to allow the electrical connection of each of the tongue major bridging conductive terminals 1241 and each of the tongue minor bridging conductive terminals 1251 to form a bridging circuit capable of transmitting ground signal

In the embodiment said above, the tongue insulation terminal frame combination 1220 has a tongue insulation terminal frame interior space 1223. It should be noted that the tongue conductive metal connection structure 1231 extends within the tongue insulation terminal frame interior space 1223, avoiding the tongue conductive metal connection structure 1231 exposing outside. The tongue conductive metal major abutting structure 12321 abuts against each of the tongue major bridging conductive terminals 1241 within the tongue insulation terminal frame interior space 1223, preventing the tongue conductive metal major abutting structure 12321 from being exposed externally. Similarly, the tongue conductive metal minor abutting structure 12331 abuts against each of the tongue minor bridging conductive terminals 1251 within the tongue insulation terminal frame interior space 1223, preventing the tongue conductive metal minor abutting structure 12331 from being exposed externally.

The combined electrical connector 1 of the present application achieves electrical connection between the conductive terminals of the electrical connector, eliminating the need for additional jumper adapters for electrical connection between the conductive terminals of the electrical connector. This allows electronic devices using the combined electrical connector 1 of the present application to continue developing in the direction of being lightweight, compact, and small. Additionally, the bridging circuit provides transmission of ground signal, enabling to reduce signal interference between the conductive terminals of the electrical connector and optimizing the transmission speed and quality of signal, meeting the specific needs and development requirements of electronic devices.

It should be noted that, in the embodiment said above, the tongue component 120 is formed by the combination of the tongue base 127, the tongue insulation terminal frame 122, the tongue bridging conductive metal 123, the tongue major conductive terminal assembly 124, and the tongue minor conductive terminal assembly 125. Therefore, after the electrical connector is designed, customization can still be achieved by separately adjusting the tongue base 127, the tongue insulation terminal frame 122, the tongue bridging conductive metal 123, the tongue major conductive terminal assembly 124, and the tongue minor conductive terminal assembly 125 to allow for the customized adjustment of the quantity, structure, and electrical connection relationships of the conductive terminals of the electrical connector to meet the specific needs and development of electronic devices

In the embodiment said above, the tongue conductive metal major abutting structure 12321 comprises a tongue conductive metal major first abutting substructure 123211 and a tongue conductive metal major second abutting substructure 123212. The tongue conductive metal major first abutting substructure 123211 is designed to abut each of the tongue major bridging conductive terminals 1241 at the tongue conductive metal major first abutting site P11, and the tongue conductive metal major second abutting substructure 123212 is intended to abut each of the tongue major bridging conductive terminals 1241 at the tongue conductive metal major second abutting site P12. Notably, the tongue conductive metal major first abutting site P11 and the tongue conductive metal major second abutting site P12 are distinct to ensure that the tongue conductive metal major abutting structure 12321 abuts each of the tongue major bridging conductive terminals 1241 at both sites, thereby ensuring that the tongue bridging conductive metal 123 can abut each of the tongue major bridging conductive terminals 1241 to form a bridging circuit that provides a transmission for ground signal.

Additionally, the tongue conductive metal minor abutting structure 12331 comprises a tongue conductive metal minor first abutting substructure 123311 and a tongue conductive metal minor second abutting substructure 123312. The tongue conductive metal minor first abutting substructure 123311 is designed to abut each of the tongue minor bridging conductive terminals 1251 at the tongue conductive metal minor first abutting site P21, and the tongue conductive metal minor second abutting substructure 123312 is intended to abut each of the tongue minor bridging conductive terminals 1251 at the tongue conductive metal minor second abutting site P22. Notably, the tongue conductive metal minor first abutting site P21 and the tongue conductive metal minor second abutting site P22 are distinct to ensure that the tongue conductive metal minor abutting structure 12331 abuts each of the tongue minor bridging conductive terminals 1251 at both positions, thereby ensuring that the tongue bridging conductive metal 123 can abut each of the tongue minor bridging conductive terminals 1251 to form a bridging circuit that provides a transmission for ground signal.

In the embodiment said above, the tongue conductive metal major abutting structure 12321 is designed as a cantilever structure, allowing the tongue bridging conductive metal 123 to flexibly abut each of the tongue major bridging conductive terminals 1241, resulting in the tongue conductive metal major abutting structure 12321 achieving a better abutment with each of the tongue major bridging conductive terminals 1241. Similarly, the tongue conductive metal minor abutting structure 12331 is designed as a cantilever structure, enabling the tongue bridging conductive metal 123 to flexibly abut each of the tongue minor bridging conductive terminals 1251, resulting in the tongue conductive metal minor abutting structure 12331 achieving a better abutment with each of the tongue minor bridging conductive terminals 1251.

Furthermore, the tongue conductive metal major separation structure 1234 extends along the tongue base separation wall 1271 and crosses over the tongue major non-bridging conductive terminal 1242 to separate the tongue major non-bridging conductive terminal 1242 from the tongue minor conductive terminal assembly 125, reducing the signal crosstalk between the tongue major non-bridging conductive terminal 1242 and the tongue minor conductive terminal assembly 125, thereby enabling to reduce signal crosstalk and optimize the transmission speed and quality of the connector for specific electronic device requirements and development. The tongue conductive metal minor separation structure 1235 extends along the tongue base separation wall 1271 and crosses over the tongue minor non-bridging conductive terminal 1252 to separate the tongue major conductive terminal assembly 124 from the tongue minor non-bridging conductive terminal 1252, reducing signal crosstalk of the tongue major conductive terminal assembly 124 from the tongue minor non-bridging conductive terminal 1252 and optimizing the transmission speed and quality of the connector for specific electronic device requirements and development.

In addition, the tongue base 127 can be a conductive plastic base to separate the tongue major conductive terminal assembly 124 and the tongue minor conductive terminal assembly 125 through the conductive plastic base, however, further enabling to reducing the signal crosstalk of the tongue major conductive terminal assembly 124 and the tongue minor conductive terminal assembly 125, optimizing the transmission speed and quality of the connector for specific electronic device requirements and development. However, it is not to be limited, the tongue base 127 can be an insulation base to provide support to the tongue bridging conductive metal 123 via the insulation base.

In the above embodiment, the tongue component 12 can enter the outer shell component 11 through the outer shell bottom embedding port 113 and is embedded in the outer shell component 11 to form the electrical connector combination 10. It should be noted that in the electrical connector combination 10, the joining portion of the tongue major conductive terminal assembly 124 and the tongue minor conductive terminal assembly 125 is exposed on the outer shell terminal joining port 111. When the outer shell component 11 is joined with the joining component 2, the joining portion of the tongue major conductive terminal assembly 124 and the tongue minor conductive terminal assembly 125 electrically joins with the joining component 2 to provide signal transmission

In addition, in the embodiment said above, the tongue insulation terminal frame major component 1221 has a tongue insulation terminal frame major separation structure 12212, and the tongue insulation terminal frame minor component 1222 has a tongue insulation terminal frame minor separation structure 12222. The tongue insulation terminal frame major separation structure 12212, for example, is a fence-like structure that separates adjacent two of the plurality of the tongue major bridging conductive terminals 1241 and the tongue major non-bridging conductive terminals 1242 to prevent electrical short circuits between adjacent two of the plurality of the tongue major bridging conductive terminals 1241 and the tongue major non-bridging conductive terminals 1242, providing protection against electrical short circuits between the plurality of the tongue major bridging conductive terminals 1241 and the tongue major non-bridging conductive terminals 1242. The tongue insulation terminal frame minor separation structure 12222 separates adjacent two of the plurality of the tongue minor bridging conductive terminals 1251 and the tongue minor non-bridging conductive terminals 1252 to prevent electrical short circuits between adjacent two of the plurality of the tongue minor bridging conductive terminals 1251 and the tongue minor non-bridging conductive terminals 1252, providing protection against electrical short circuits between the plurality of tongue minor bridging conductive terminals 1251 and the tongue minor non-bridging conductive terminals 1252.

In the embodiment said above, the tongue insulation terminal frame 122 has a tongue insulation terminal frame joining structure 1224. In the electrical connector combination 10, the tongue insulation terminal frame joining structure 1224 is engaged with the outer shell component 11 in a snapping, fastening, or interference manner, allowing the tongue insulation terminal frame 122 to be integrated with the outer shell component 11 as a single unit. Therefore, the tongue insulation terminal frame joining structure 1224 can be a snapping structure, a fastening structure, or an interference structure.

It should be noted that in the embodiment said above, certain components mentioned earlier can be omitted. For example, in this application, the combined electrical connector includes an outer shell component and a tongue component. The outer shell component provides to be joined with the joining component. The tongue component comprises a tongue base, a tongue insulation terminal frame major component, a tongue insulation terminal frame minor component, a tongue bridging conductive metal, a tongue major conductive terminal assembly, and a tongue minor conductive terminal assembly. The tongue major conductive terminal assembly includes a plurality of tongue major bridging conductive terminals and tongue major non-bridging conductive terminals. The tongue minor conductive terminal assembly includes a plurality of tongue minor bridging conductive terminals and tongue minor non-bridging conductive terminals. The tongue bridging conductive metal includes a tongue conductive metal connection structure, a tongue conductive metal major abutting structure, and a tongue conductive metal minor abutting structure. The tongue base includes a tongue base separation wall. The tongue insulation terminal frame major component includes a tongue insulation terminal frame major joining structure and the tongue insulation terminal frame minor component has a tongue insulation terminal frame minor joining structure. The tongue insulation terminal frame major joining structure and the tongue insulation terminal frame minor joining structure are joined with opposite two side of the tongue major conductive terminal assembly and the tongue minor conductive terminal assembly, respectively, providing positioning for the tongue major conductive terminal assembly and the tongue minor conductive terminal assembly. The tongue base, the tongue insulation terminal frame major joining structure, the tongue insulation terminal frame minor joining structure, the tongue bridging conductive metal, the tongue major conductive terminal assembly, and the tongue minor conductive terminal assembly are combined to form the tongue component combination. In the tongue component assembly, the tongue base separation wall separates the tongue major conductive terminal assembly and the tongue minor conductive terminal assembly. The tongue conductive metal connection structure extends and respectively crosses over the tongue major non-bridging conductive terminals and the tongue minor non-bridging conductive terminals, allowing the tongue conductive metal connection structure to respectively electrically connect with the tongue conductive metal major abutting structure and the tongue conductive metal minor abutting structure. The tongue conductive metal major abutting structure abuts each of the tongue major bridging conductive terminals, and the tongue conductive metal minor abutting structure abuts each of the tongue minor bridging conductive terminals, allowing each of the tongue major bridging conductive terminals and each of the tongue minor bridging conductive terminals to be electrically connected. The tongue component is embedded in the outer shell component to form an electrical connector combination. In the electrical connector combination, the joining portion of the tongue major conductive terminal assembly and the tongue minor conductive terminal assembly expose on the outer shell terminal joining port. When the outer shell component is joined with the joining component, the joining portion of the tongue major conductive terminal assembly and the tongue minor conductive terminal assembly electrically join with the joining component.

In summary, the combined electrical connector provided in this application is at least composed of an outer shell component and a tongue component. The tongue component is at least composed of a tongue base, a tongue insulation terminal frame, a tongue bridging conductive metal, a tongue major conductive terminal assembly, and a tongue minor conductive terminal assembly. Therefore, after the electrical connector design is completed, customization and adjustment of the quantity, structure, and electrical connection relationship of the conductive terminals of the electrical connector can still be achieved by adjusting the outer shell component and the tongue component. This allows meeting the specific requirements and developments of electronic devices.

Additionally, the tongue bridging conductive metal can achieve electrical connection between certain conductive terminals of the electrical connector, reducing signal crosstalk between certain conductive terminals of the electrical connector to enhance the transmission speed and quality of signal of the electrical connector. Furthermore, this application eliminates the need for additional jumper adapters to achieve electrical connection between certain conductive terminals in the electrical connector to allow electronic devices equipped with the combined electrical connector disclosed in this application to continue evolving towards a direction of being lightweight, compact, and small.

The examples above are only illustrative to explain principles and effects of the invention, but not to limit the invention. It will be apparent to those skilled in the art that modifications and variations can be made without departing from the spirit and scope of the invention. Therefore, the protection range of the rights of the invention should be as defined by the appended claims.

What is claimed is:

1. A combined electrical connector, which is used with a joining component, comprising:
an outer shell component providing joining with the joining component wherein the outer shell component has an outer shell terminal joining port;
a tongue component including a tongue base, a tongue insulation terminal frame, a tongue bridging conductive metal, a tongue major conductive terminal assembly, and a tongue minor conductive terminal assembly; wherein
the tongue major conductive terminal assembly includes a plurality of tongue major bridging conductive terminals and a tongue major non-bridging conductive terminal, and the tongue minor conductive terminal assembly includes a plurality of tongue minor bridging conductive terminals and a tongue minor non-bridging conductive terminal;
the tongue bridging conductive metal comprises a tongue conductive metal connection structure, a tongue conductive metal major abutting structure, and a tongue conductive metal minor abutting structure;
the tongue base includes a tongue base separation wall;
the tongue insulation terminal frame includes a tongue insulation terminal frame major joining structure and a tongue insulation terminal frame minor joining structure, and the tongue insulation terminal frame major joining structure and the tongue insulation terminal frame minor joining structure are used to respectively join with one side of the tongue major conductive terminal assembly and the tongue minor conductive terminal assembly, providing positioning for the tongue major conductive terminal assembly and the tongue minor conductive terminal assembly; wherein
the tongue base, the tongue insulation terminal frame, the tongue bridging conductive metal, the tongue major conductive terminal assembly, and the tongue minor conductive terminal assembly are combined to form a tongue component combination, within the tongue component combination, the tongue base separation wall separates the tongue major conductive terminal assembly from the tongue minor conductive terminal assembly, wherein the tongue conductive metal connection structure extends to respectively cross over the tongue major non-bridging conductive terminal and the tongue minor non-bridging conductive terminal, allowing the tongue conductive metal connection structure to respectively electrically connect with the tongue conductive metal major abutting structure and the tongue conductive metal minor abutting structure, and the tongue conductive metal major abutting structure abuts to each of the tongue major bridging conductive terminals, and the tongue conductive metal minor abutting structure abuts to each of the tongue minor bridging conductive terminals, allowing for the electrical connection of each of the tongue major bridging conductive terminals and each of the tongue minor bridging conductive terminals; and
the tongue component is embedded within the outer shell component to form an electrical connector combination, in the electrical connector combination, the contact area of the tongue major conductive terminal assembly and the tongue minor conductive terminal assembly are exposed on the outer shell terminal joining port, allowing the contact area of tongue major conductive assembly and the tongue minor conductive assembly is electrically connected with the joining component when the outer shell component is joined to the joining component.

2. A combined electrical connector of claim 1, wherein the outer shell component further includes an outer shell lingual structure, an outer shell bottom embedding port, and an outer shell interior space, and the outer shell bottom embedding port is located at the bottom of the outer shell lingual structure, while the outer shell interior space is positioned within the interior of the outer shell lingual structure, wherein the outer shell terminal joining port is positioned on the side wall of the outer shell lingual structure, and the tongue component can enter the outer shell interior space through the outer shell bottom embedding port, thereby exposing the contact area of the tongue major conductive terminal assembly and the tongue minor conductive terminal assembly on the outer shell terminal joining port.

3. A combined electrical connector of claim 1, wherein the outer shell component further includes an outer shell component major separation structure and an outer shell component minor separation structure, in the electric connector combination, the outer shell major component separation structure serves to separate adjacent pairs of the plurality of the tongue major bridging conductive terminals from the tongue major non-bridging conductive terminal, and the outer shell minor component separation structure serves to separate adjacent pairs of the plurality of the tongue minor bridging conductive terminals from the tongue minor non-bridging conductive terminal.

4. A combined electrical connector of claim 1, wherein the tongue base further includes a tongue base support structure, and the tongue base support structure provides support to the tongue conductive metal connection structure, allowing the tongue conductive metal connection structure to extend on the tongue base.

5. A combined electrical connector of claim 4, wherein the tongue conductive metal connection structure spans across or abuts the tongue base separation wall.

6. A combined electrical connector of claim 4, wherein the tongue bridging conductive metal further includes a tongue conductive metal major separation structure and a tongue conductive metal minor separation structure, and the tongue conductive metal major separation structure extends along the tongue base separation wall, bridging over the tongue major non-bridging conductive terminal to separate the tongue major non-bridging conductive terminal from the tongue minor conductive terminal assembly, wherein the tongue conductive metal minor separation structure extends along the tongue base separation wall, bridging over the tongue minor non-bridging conductive terminals to separate the tongue major conductive terminal assembly from the tongue minor non-bridging conductive terminal.

7. A combined electrical connector of claim 1, wherein the tongue conductive metal major abutting structure comprises a tongue conductive metal major first abutting substructure and a tongue conductive metal major second abutting substructure, and the tongue conductive metal major first abutting substructure is used to abut against each of the tongue major bridging conductive terminals at a tongue conductive metal major first abutting position, while the tongue conductive metal major second abutting substructure is used to abut against each of the tongue major bridging conductive terminals at a tongue conductive metal major second abutting position, wherein the tongue conductive metal major first abutting position and the tongue conductive metal major second abutting position are different; the tongue conductive metal minor abutting structure comprises a tongue conductive metal minor first abutting substructure and a tongue conductive metal minor second abutting substructure, and the tongue conductive metal minor first abutting substructure is used to abut against each of the tongue minor bridging conductive terminals at a tongue conductive metal minor first abutting position, while the tongue conductive metal minor second abutting substructure is used to abut against each of the tongue minor bridging conductive terminals at a tongue conductive metal minor second abutting position, wherein the tongue conductive metal minor first abutting position and the tongue conductive metal minor second abutting position are different.

8. A combined electrical connector of claim 1, wherein the tongue insulation terminal frame comprises a tongue insulation terminal frame major component and a tongue insulation terminal frame minor component, and the tongue insulation terminal frame major joining structure is located on the tongue insulation terminal frame major component, and the tongue insulation terminal frame minor joining structure is located on the tongue insulation terminal frame minor component, wherein the tongue insulation terminal frame major component includes a tongue insulation terminal frame major assembly structure, while the tongue insulation terminal frame minor component includes a tongue insulation terminal frame minor assembly structure, the tongue insulation terminal frame major assembly structure and the tongue insulation terminal frame minor assembly structure are structurally coordinated, allowing the tongue insulation terminal frame major component and the tongue insulation terminal frame minor component to be assembled into a tongue insulation terminal frame combination.

9. A combined electrical connector of claim 8, wherein the tongue base further includes a tongue base assembly structure, and the tongue base assembly structure is respectively structurally coordinated with the tongue insulation terminal frame major assembly structure and the tongue insulation terminal frame minor assembly structure, enabling the tongue insulation terminal frame major component and the tongue insulation terminal frame minor component to be assembled into the tongue insulation terminal frame combination.

10. A combined electrical connector, which is used with a joining component, comprising:
an outer shell component providing joining with the joining component;
a tongue component including a tongue base, a tongue insulation terminal frame major component, a tongue insulation terminal frame minor component, a tongue bridging conductive metal, a tongue major conductive terminal assembly, and a tongue minor conductive terminal assembly; wherein
the tongue major conductive terminal assembly includes a plurality of tongue major bridging conductive terminals and a tongue major non-bridging conductive terminal, and the tongue minor conductive terminal assembly includes a plurality of tongue minor bridging conductive terminals and a tongue minor non-bridging conductive terminal;
the tongue bridging conductive metal comprises a tongue conductive metal connection structure, a tongue conductive metal major abutting structure, and a tongue conductive metal minor abutting structure;
the tongue base includes a tongue base separation wall;
the tongue insulation terminal frame includes a tongue insulation terminal frame major joining structure, and the tongue insulation terminal frame minor component includes a tongue insulation terminal frame minor joining structure, the tongue insulation terminal frame major joining structure and the tongue insulation terminal frame minor joining structure are used to respectively join with opposite sides of the tongue major conductive terminal assembly and the tongue minor conductive terminal assembly, providing positioning for the tongue major conductive terminal assembly and the tongue minor conductive terminal assembly; wherein
the tongue base, the tongue insulation terminal frame major component, the tongue insulation terminal frame minor component, the tongue bridging conductive metal, the tongue major conductive terminal assembly, and the tongue minor conductive terminal assembly are combined to form a tongue component combination, within the tongue component combination, the tongue base separation wall separates the tongue major conductive terminal assembly from the tongue minor conductive terminal assembly, wherein the tongue conductive metal connection structure extends to respectively cross over the tongue major non-bridging conductive terminal and the tongue minor non-bridging conductive terminal, allowing the tongue conductive metal connection structure to respectively electrically connect with the tongue conductive metal major abutting structure and the tongue conductive metal minor abutting structure, and the tongue conductive metal major abutting structure abuts to each of the tongue major bridging conductive terminals, and the tongue conductive metal minor abutting structure abuts to each of the tongue minor bridging conductive terminals, allowing for the electrical connection of each of the tongue major bridging conductive terminals and each of the tongue minor bridging conductive terminals; and
the tongue component is embedded within the outer shell component to form an electrical connector combination, in the electrical connector combination, the contact area of the tongue major conductive terminal assembly and the tongue minor conductive terminal assembly are exposed on the outer shell component, allowing the contact area of tongue major conductive assembly and the tongue minor conductive assembly is electrically connected with the joining component when the outer shell component is joined to the joining component.

11. A combined electrical connector of claim 10, wherein the outer shell component includes an outer shell bottom embedding port, wherein the tongue component combination enables to enter the outer shell component via the outer shell bottom embedding port to form the electrical connector combination.

12. A combined electrical connector of claim 10, wherein the tongue insulation terminal frame major component further includes a tongue insulation terminal frame major separation structure, and the tongue insulation terminal frame minor component includes a tongue insulation terminal frame minor separation structure, wherein the tongue insulation terminal frame major separation structure serves to separate adjacent pairs of the plurality of the tongue major bridging conductive terminals from the tongue major non-bridging conductive terminal, and the tongue insulation terminal frame minor separation structure serves to separate adjacent pairs of the plurality of the tongue minor bridging conductive terminals from the tongue minor non-bridging conductive terminal.

13. A combined electrical connector of claim 12, wherein the tongue insulation terminal frame major separation structure and the tongue insulation terminal frame minor separation structure are fence-like structure.

14. A combined electrical connector of claim 10, wherein the tongue base further includes a tongue base support structure, and the tongue base support structure provides support to the tongue conductive metal connection structure, allowing the tongue conductive metal connection structure to extend on the tongue base.

15. A combined electrical connector of claim 10, wherein the tongue conductive metal connection structure spans across or abuts the tongue base separation wall.

16. A combined electrical connector of claim 10, wherein the tongue bridging conductive metal further includes a tongue conductive metal major separation structure and a tongue conductive metal minor separation structure, and the tongue conductive metal major separation structure extends along the tongue base separation wall, bridging over the tongue major non-bridging conductive terminal to separate the tongue major non-bridging conductive terminal from the tongue minor conductive terminal assembly, wherein the tongue conductive metal minor separation structure extends along the tongue base separation wall, bridging over the tongue minor non-bridging conductive terminals to separate the tongue major conductive terminal assembly from the tongue minor non-bridging conductive terminal.

17. A combined electrical connector of claim 10, wherein the tongue conductive metal major abutting structure comprises a tongue conductive metal major first abutting substructure and a tongue conductive metal major second abutting substructure, and the tongue conductive metal major first abutting substructure is used to abut against each of the tongue major bridging conductive terminals at a tongue conductive metal major first abutting position, while the tongue conductive metal major second abutting substructure is used to abut against each of the tongue major bridging conductive terminals at a tongue conductive metal major second abutting position, wherein the tongue conductive metal major first abutting position and the tongue conductive metal major second abutting position are different; the tongue conductive metal minor abutting structure comprises a tongue conductive metal minor first abutting substructure and a tongue conductive metal minor second abutting substructure, and the tongue conductive metal minor first abutting substructure is used to abut against each of the tongue minor bridging conductive terminals at a tongue conductive metal minor first abutting position, while the tongue conductive metal minor second abutting substructure is used to abut against each of the tongue minor bridging conductive terminals at a tongue conductive metal minor second abutting position, wherein the tongue conductive metal minor first abutting position and the tongue conductive metal minor second abutting position are different.

18. A combined electrical connector of claim 10, wherein the tongue insulation terminal frame major component comprises a tongue insulation terminal frame major assembly structure, and the tongue insulation terminal frame minor component includes a tongue insulation terminal frame minor assembly structure, wherein the tongue insulation terminal frame major assembly structure and the tongue insulation terminal frame minor assembly structure are structurally coordinated, allowing the tongue insulation terminal frame major component and the tongue insulation terminal frame minor component to be assembled into a tongue insulation terminal frame combination.

19. A combined electrical connector of claim 18, wherein the tongue insulation terminal frame combination includes a tongue insulation terminal frame joining structure, in the electrical connector combination, the tongue insulation terminal frame joining structure is joined with the outer shell component through a snap-in, fastening, or interference method.

20. A combined electrical connector of claim 18, wherein the tongue insulation terminal frame combination includes a tongue insulation terminal frame interior space; wherein the tongue conductive metal connection structure extends in the tongue insulation terminal frame interior space, wherein the tongue conductive metal major abutting structure abuts each of the tongue major bridging conductive terminals, and the tongue conductive metal minor abutting structure abuts each of the tongue minor bridging conductive terminals in the tongue insulation terminal frame interior space.
